(19) United States
(12) Patent Application Publication
(10) Pub. No.: US 2026/0361592 A1
(43) Pub. Date: Nov. 12, 2026

(54) SYSTEMS AND METHODS FOR PERFORMANCE DRIFT DETECTION VIA ENCODER-DECODER MODELS

(71) Applicant: Nile Global, Inc., San Jose, CA (US)

(72) Inventor: Ebrahim Safavi, San Jose, CA (US)

(21) Appl. No.: 19/205,875

(22) Filed: May 12, 2025

(51) Int. Cl. H04L 41/0631; H04L 41/16; H04L 43/08

(52) U.S. Cl. CPC H04L 41/0631; H04L 41/16; H04L 43/08

(57) ABSTRACT

An alert may be produced in response to detecting abnormal network performance as follows. A machine learning model produces a predicted mean vector and a variance vector in response to receiving a sequence of network performance metric vectors. The abnormal network performance is detected in response to determining that a network vector sample is outside of a permissible envelope that is defined by the predicted mean vector and the variance vector. Finally, the alert is produced in response to detecting the abnormal network performance. The network vector sample and each of the network performance metric vectors may include a plurality of values corresponding to a plurality of network performance metrics.

### TECHNICAL FIELD

The systems and methods relate to computer networks, wireless networks, WiFi networks, network device interactions with computer networks, network events, authentication, and verification. The systems and methods also relate to using time sequences of events to monitor network performance.

### BACKGROUND

Wireless networks such as WiFi networks have been widely deployed and are widely used. The Institute of Electrical and Electronics Engineers (IEEE) has produced and maintains the standards for Ethernet and for WiFi. The IEEE 802.3 family of standards are directed to Ethernet which uses wired connections. For wireless networking, the IEEE 802.11 family of standards specify many aspects of WiFi communications. IEEE 802.3 and 802.11 specify network protocols, network packet contents, and the formats of packet headers. The packet headers include fields such as source and destination media access control (MAC) addresses that may be used as device identifiers. Networks may therefore include numerous network devices, including WiFi devices and wired devices. The network devices provide networking services for user devices such as personal computers, smartphones, etc. An important aspect of providing networking services is measuring network performance and detecting when network performance has degraded or is not normal. Networking performance may suffer due to cyber-attacks, unusual user behavior, and abnormally performing network devices. In an example, a network device may be upgraded by installing a new version of operational software. Ideally, the new software improves network performance or maintains a current level of performance. Less ideally, an upgrade degrades network performance. Such degraded performance should be detected and the upgrade rolled back. Systems and methods for detecting abnormal network performance are needed.

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the subject matter described in this disclosure can be implemented by a method that produces an alert in response to detecting abnormal network performance. The method may include producing, by machine learning model, a predicted mean vector and a variance vector in response to receiving a sequence of network performance metric vectors, detecting the abnormal network performance in response to determining that a network vector sample is outside of a permissible envelope that is defined by the predicted mean vector and the variance vector, and producing the alert in response to detecting the abnormal network performance, wherein the network vector sample and each of the network performance metric vectors include a plurality of values corresponding to a plurality of network performance metrics.

Another aspect of the subject matter described in this disclosure can be implemented by a method. The method may include producing a trained machine learning model configured to produce a predicted mean vector and a variance vector in response to receiving a sequence of network performance metric vectors. The method may produce the predicted mean vector and the variance vector in response to receiving the sequence of network performance metric vectors by instantiating a machine learning model, obtaining a first mean vector and a first variance vector by providing a first training sequence to the machine learning model, calculating a first distance between the first mean vector and a first desired outcome, determining an unpenalized loss in response to using the first variance vector to determine that the first distance is a permissible distance, using the unpenalized loss and backpropagation to adjust a plurality of weights of the machine learning model, obtaining a second mean vector and a second variance vector by providing a second training sequence to the machine learning model, calculating a second distance between the second mean vector and a second desired outcome, determining a penalized loss in response to using the second variance vector to determine that the second distance is an impermissible distance, and using the penalized loss and backpropagation to adjust the weights of the machine learning model.

Yet another aspect of the subject matter described in this disclosure can be implemented by a system. The system may include a memory configured to store a machine learning model and to store a sequence of network performance metric vectors and a network vector sample, and a processor configured to produce an alert in response to detecting abnormal network performance. Detecting the abnormal network performance may include producing a predicted mean vector and a variance vector by providing the sequence of network performance metric vectors to the machine learning model and detecting the abnormal network performance in response to determining that the network vector sample is outside of a permissible envelope that is defined by the predicted mean vector and the variance vector, wherein the network vector sample and each of the network performance metric vectors and include a plurality of values corresponding to a plurality of network performance metrics.

In some implementations of the methods and devices, the machine learning model includes an encoder-decoder model. In some implementations of the methods and devices, the machine learning model includes a transformer. In some implementations of the methods and devices, the predicted mean vector includes predicted mean values corresponding to the network performance metrics, and the variance vector includes a plurality of log-variance predictions corresponding to the predicted mean values.

In some implementations of the methods and devices, the predicted mean vector indicates a center of the permissible envelope and the variance vector indicates a size of the permissible envelope. In some implementations of the methods and devices, the sequence of network performance metric vectors is a time series of network performance metric vectors corresponding to successive points in time at uniform intervals. In some implementations of the methods and devices, the network performance metric vectors include a received signal strength indicator (RSSI) range count indicator corresponding to a number of user devices within an RSSI range. In some implementations of the methods and devices, the network performance metric vectors include a plurality of dynamic host configuration protocol (DHCP) event count indicators corresponding to a number of user devices corresponding to a plurality of DHCP event types. In some implementations of the methods and devices, each one of the user devices is represented no more than once in each one of DHCP event count indicators. In some implementations of the methods and devices, the network performance metric vectors include a plurality of latency range count indicators corresponding to a number of user devices experiencing latency within specified ranges. In some implementations of the methods and devices, the latency range count indicators correspond to a plurality of connection types.

In some implementations of the methods and devices, the network performance metric vectors include a value determined from a count that indicates a number of user devices corresponding to a network performance metric, and the value is produced by a function that maps the count to a range bounded by zero and one, the value asymptotically approaching one as the count approaches infinity.

In some implementations of the methods and devices, the method further includes training the machine learning model, wherein training the machine learning model includes obtaining a candidate mean vector and a candidate variance vector by providing a training sequence to the machine learning model, calculating a loss that represents a distance between the candidate mean vector and a desired outcome, increasing the loss in response to determining that the distance is an impermissible distance, and using backpropagation to adjust a plurality of weights of the machine learning model based on the loss.

### BRIEF DESCRIPTION OF THE DRAWINGS

FIG. 1 is a high-level block diagram illustrating an example of a network that uses a trained machine learning model to detect abnormal network performance, according to some aspects.

FIG. 2 is a high-level block diagram illustrating an example of gathering measurements from user devices to produce network performance metric vectors, according to some aspects.

FIG. 3 is a high-level block diagram illustrating an example of a host machine that may detect abnormal network behavior, according to some aspects.

FIG. 4 is a high-level block diagram illustrating an example of a software system according to some aspects.

FIG. 5 is a high-level flow diagram illustrating an example of producing and storing network training vectors corresponding to numerous sites and time periods, according to some aspects.

FIG. 6 is a high-level flow diagram illustrating an example of producing a network training vector corresponding to a client site and a time period, according to some aspects.

FIG. 7 is a high-level flow diagram illustrating an example of producing a value for a network performance metric corresponding to a client site and a time period, according to some aspects.

FIG. 8 is a high-level flow diagram illustrating an example of producing a range count indicator from a set of records, according to some aspects.

FIG. 9 is a high-level flow diagram illustrating an example of producing an event count indicator from a set of records, according to some aspects.

FIG. 10A is a high-level block diagram illustrating an example of a classic transformer configured to produce a vector of output probabilities , according to some aspects.

FIG. 10B illustrates an example of a transformer configured as a variational autoencoder that produces a predicted mean vector and a variance vector, according to some aspects.

FIG. 11 is a high-level block diagram illustrating examples of functions that may be used for normalizing values in a network performance metric vector, according to some aspects.

FIG. 12 is a high-level block diagram illustrating an example of calculating a loss that represents a distance between the candidate mean vector and a desired outcome, according to some aspects.

FIG. 13 is a high-level flow diagram illustrating an example of a process that determines that a predicted mean vector is an impermissible distance from a desired vector, according to some aspects.

FIG. 14 is a high-level flow diagram illustrating an example of training a machine learning model to produce a predicted mean vector and a variance vector in response to receiving a sequence of network performance metric vectors, according to some aspects.

FIG. 15 is a high-level flow diagram illustrating an example of using a machine learning model to produce an alert in response to detecting abnormal network performance, according to some aspects.

FIG. 16 is a high-level block diagram illustrating examples of composite metric definitions according to some aspects.

FIG. 17 is a high-level block diagram illustrating an example of a machine learning model producing a predicted mean vector and a variance vector in response to receiving a sequence of network performance metric vectors, according to some aspects.

FIGS. 18A-18E are high-level conceptual diagrams illustrating an example of a table of events that may correspond to composite metrics that may be summed, according to some aspects.

FIG. 19 is a high-level timing diagram illustrating an example of using a machine learning model to produce an alert in response to detecting abnormal network performance after an upgrade, according to some aspects.

FIG. 20 is a high-level flow diagram illustrating an example of using a machine learning model to produce an alert in response to detecting abnormal network performance after an upgrade, according to some aspects.

FIG. 21 is a high-level flow diagram illustrating an example of a method that uses a machine learning model to produce an alert in response to detecting abnormal network performance, according to some aspects.

FIG. 22 is a high-level flow diagram illustrating an example of a method that trains a machine learning model to produce a predicted mean vector and a variance vector in response to receiving a sequence of network performance metric vectors, according to some aspects.

FIG. 23 is a high-level flow diagram illustrating an example of a method that produces an upgrade performance indicator for a network device, according to some aspects.

FIG. 24 is a high-level flow diagram illustrating an example of a cloud service, according to some aspects.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure but is merely representative of various examples. While the various aspects of the examples are presented in drawings, the drawings are not necessarily drawn to scale unless specifically indicated.

The described examples are to be considered in all respects only as illustrative and not restrictive. The scope of the claimed matter is therefore indicated by the appended claims rather than by this detailed description. All changes which come within the meaning and range of equivalency of the claims are to be embraced within their scope.

Reference throughout this specification to features, advantages, or similar language does not imply that all the features and advantages that may be realized should be realized in any single example. Rather, language referring to the features and advantages is understood to mean that a specific feature, advantage, or characteristic described in connection with an example is included in at least one implementation. Thus, discussions of the features and advantages, and similar language, throughout this specification may, but do not necessarily, refer to the same example.

Furthermore, the described features, advantages, characteristics, and aspects may be combined in any suitable manner in one or more examples. One skilled in the relevant art will recognize from the description herein that one example may be practiced without one or more of the specific features or advantages of another example. In other instances, additional features and advantages may be recognized in certain examples that may not be present in all examples.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

A computer network is implemented by numerous network devices and exists to serve its users. The network devices can include routers, switches, wireless access points, and other hardware devices. The users may be people or networked machines (e.g., printers, video systems, manufacturing equipment, autonomous vehicles, etc.) An important aspect of running a computer network is monitoring the computer network and detecting abnormal network performance or other network performance issues that result in a decline or worsening of the users’ experience. Prompt detection of network performance issues allows for prompt corrective action. In the past individual devices were monitored. A more comprehensive solution is to monitor the entire network using network performance metrics measuring the performance of the entire network. A machine learning (ML) model may be used to detect changes in network performance. Network performance may change due to a variety of factors such as upgrades to one or more network devices (includes configuration changes such as modifying networking rules), cyber-attacks, device failures, and changes amongst the users.

The networking devices that implement the computer network may send performance metrics to a server that stores the performance metrics in performance metric storage. The stored performance metrics may be processed to produce performance metric vectors that include composite metrics and non-composite metrics. A composite metric is a metric that is produced from the performance metrics of numerous network devices. A non-composite metric may be a measurement received from a network device. An example of a composite network performance metric is the number of successful WiFi association requests within the network that may be determined by summing the number of successful WiFi association requests of each WiFi access point. An example of a non-composite network performance metric is the number of successful WiFi association requests for a specific WiFi access point. A sequence of network performance metrics may be input to a machine learning model such as an encoder-decoder model. Many large language models are encoder-decoder models that predict a next token in response to receiving a sequence of previous tokens, the tokens being tokenized words. Here, the machine learning model may produce a predicted next network performance metric vector, called a predicted mean vector, in response to receiving a sequence of previous network performance metric vectors. The actual next network performance metric vector may be compared to the predicted mean vector to detect abnormal network performance. For example, abnormal network performance may be defined as network performance that results in a network performance metric vector that is outside a permissible envelope centered on the predicted mean vector. In an example, the permissible envelope is defined by distances in each dimension of the network performance metric vector. Each dimension corresponds to a network performance metric.

As is known in the art of machine learning, variational autoencoders are encoder-decoder models that produce a variance vector as well as the predicted next token. One purpose for the prior art models to produce a variance vector is to provide guidance in selecting a next token that is not the highest probability token, as was the case in some early ML models. Here, the variance vector may be used to define the permissible envelope. For example, the predicted next vector may be the center of the permissible envelope and the variance vector may define the size of the permissible envelope. For example, the size may be defined as three standard deviations from the predicted mean for each metric.

Machine learning has made stunning advances in recent years. One such advance is the encoder-decoder network, introduced in 2014 through two influential papers: "Sequence to Sequence Learning with Neural Networks" by Sutskever, Vinyals, and Le; and "Learning Phrase Representations using RNN Encoder-Decoder for Statistical Machine Translation" by Cho et al. As such, RNN encoder-decoder models were introduced in 2014. Development continued. Two additional encoder-decoder models were introduced in 2017: Convolutional Neural Network (CNN) encoder-decoder models; and transformer based encoder-decoder models. Transformer based models were introduced in the paper: "Attention is All You Need" by Ashish Vaswani, Noam Shazeer, Niki Parmar, Jakob Uszkoreit, Llion Jones, Aidan N. Gomez, Lukasz Kaiser, and Illia Polosukhin, published in the proceedings of the Neural Information Processing Systems (NIPS) conference in 2017. Since then, a great many different encoder-decoder models have been introduced, including hybrid architectures that combine different types of encoder and decoder layers such as RNN layers in combination with CNN or transformer layers, etc. In testing, a transformer based encoder-decoder has produced useful levels of detection of abnormal network performance. The transformer used had 4 layer multi-headed attention, eight attention heads, a model dimension of 512, an embedding dimension of , a 0.2 dropout rate, an input length of 100 (M=100), and an output length of 50 (N=50).

In 2024, machine learning libraries (e.g., pytorch, tensorflow, etc.) and large language models (LLMs) have made the enablement of machine learning applications very approachable. For example, an initial step of project development may be to ask a LLM (e.g., “Claude” at https://claude.ai”) to provide a python program for a 4 layer RNN encoder-decoder for sequence to sequence prediction having 100 encoder inputs and 50 decoder inputs. In response, Claude produces a python program that, after some trouble shooting, may be the core of a machine learning application that uses a RNN based encoder-decoder model. Similar requests may be made for other encoder-decoder models such as CNN models, transformer models, hybrid models, etc. Regardless of whether an experienced machine learning practitioner, an inexperienced practitioner with an LLM helper, or some other entity programs and trains the machine learning model, the result is a useful application. It is a useful application for detecting abnormal network performance. The useful application is not, however, limited to detecting abnormal network performance. Furthermore, examples of the code for implementing ML models may be readily downloaded from publicly available code repositories such as github.com, huggingface.co, etc.) Such publicly available examples include RNN encoder-decoders, CNN encoder-decoders, transformers, variational autoencoders, etc.

Using a machine learning model that produces a predicted mean vector and a variance vector of to detect changes in network performance brings advantages over other techniques. Those advantages may include: manual threshold tuning is not required; multi-metric correlations are captured; detection of the need for rollback after a software upgrade; and automatic self-normalization to site specific baselines.

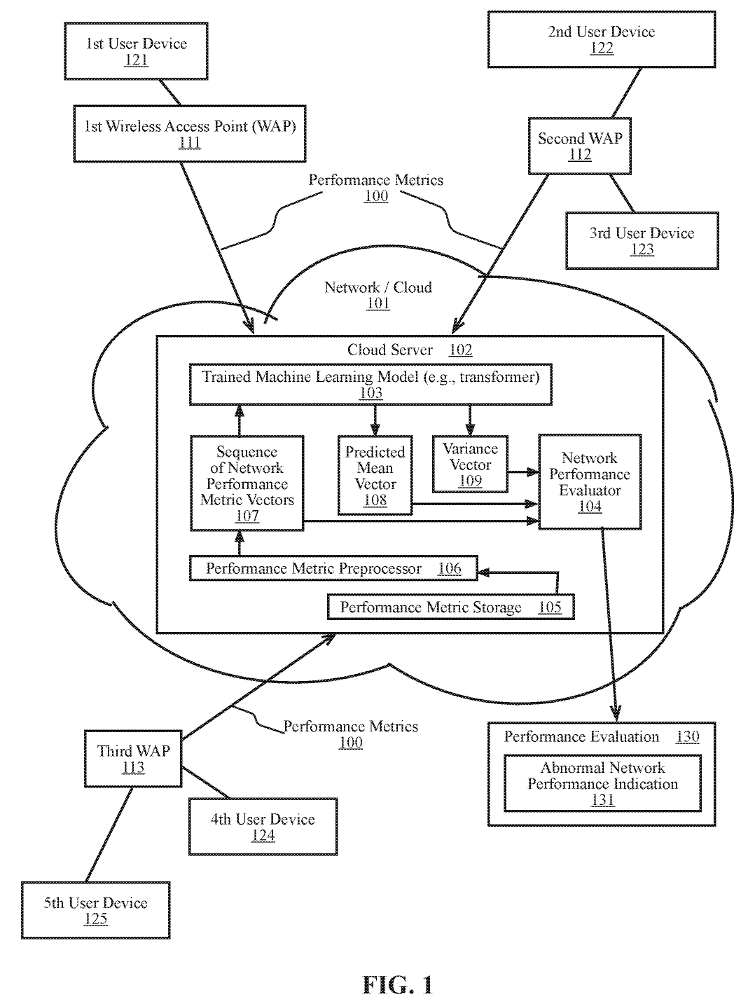

FIG. 1 is a high-level block diagram illustrating an example of a network that uses a trained machine learning model 103 to detect abnormal network performance, according to some aspects. A network can include network devices such as a first wireless access point (WAP) 111, a second WAP 112, and a third WAP 113. The network can also include devices (routers, switches, etc.) that provide wired connectivity. User devices may connect to the network via the WAPs. FIG. 1 shows the first user device 121 connecting to the network via the first WAP 111, the second user device 122 connecting to the network via the second WAP 112, the third user device 123 connecting to the network via the second WAP 112, the fourth user device 124 connecting to the network via the third WAP 113, and the fifth user device 125 connecting to the network via the third WAP 113. The user devices may include devices used by people to access the network (e.g., laptop computer, desktop computer, smart phone, etc.). The user devices may include systems and devices that connect to the network in order to communicate with other machines, other devices, or with people (e.g., servers, autonomous vehicles, printers, scanners, cameras, robots, manufacturing machines, etc.). The WAPs may communicate with one another and with other network devices via a network cloud 101, which can include various network devices, wired connections, and wireless connections providing connectivity. Note that the WAPs may be considered as part of the network cloud 101. The cloud may also include servers such as cloud server 102. In an example, the user devices are within a client site (e.g., a building or campus) and the cloud server is within a data center that may be thousands of miles away from the client site.

In an example, the cloud server 102 includes storage such as performance metric storage 105 and runs processes that include a performance metric preprocessor 106, a trained machine learning model 103, and a network performance evaluator 104. The storage and processes shown in the cloud server may be in a single computer or may be in numerous computers. The WAPs and other network devices may send performance metric reports that include performance metrics 100 to the cloud server for storage in the performance metric storage 105. The performance metric reports may include values corresponding to network performance metrics (e.g., latency measurements, signal strengths, etc.). The data in the performance metric reports may be stored in the performance metric storage 105 and accessed by the performance metric preprocessor 106. The performance metric preprocessor 106 can produce network performance metric vectors by processing the data received from the network devices and stored in the performance metric storage 105. As such, the performance metric preprocessor 106 may produce sequences of network performance metric vectors 107. In some examples, the sequence of network performance metric vectors 107 is a time series of network performance metric vectors corresponding to successive points in time at uniform intervals. In other examples, the sequence of network performance metric vectors 107 includes network performance metric vectors corresponding to points in time that may be successive points in time or non-successive points in time.

The trained machine learning model 103 may produce a predicted mean vector 108 and a variance vector 109 in response to receiving the sequence of network performance metric vectors 107. In an example, the predicted mean vector 108 is the trained machine learning model's prediction of the next network performance metric vector following the sequence of network performance metric vectors 107. In such an example, the trained machine learning model 103 may be an encoder-decoder model (e.g., a transformer). It is known in the art that encoder-decoder models such as transformers are well suited to predicting a next token following a sequence of tokens. Here, the trained machine learning model 103 predicts a next network performance metric vector. The network performance evaluator 104 may produce a performance evaluation 130 in response to receiving the predicted mean vector 108 and the variance vector 109. In an example, the performance evaluation 130 is an alert that the network performance evaluator 104 produces in response to detecting abnormal network performance. As such, the performance evaluation 130 includes an abnormal network performance indication 131. The alert may be a text message, email, notification, or other communication that indicates that abnormal network performance has been detected.

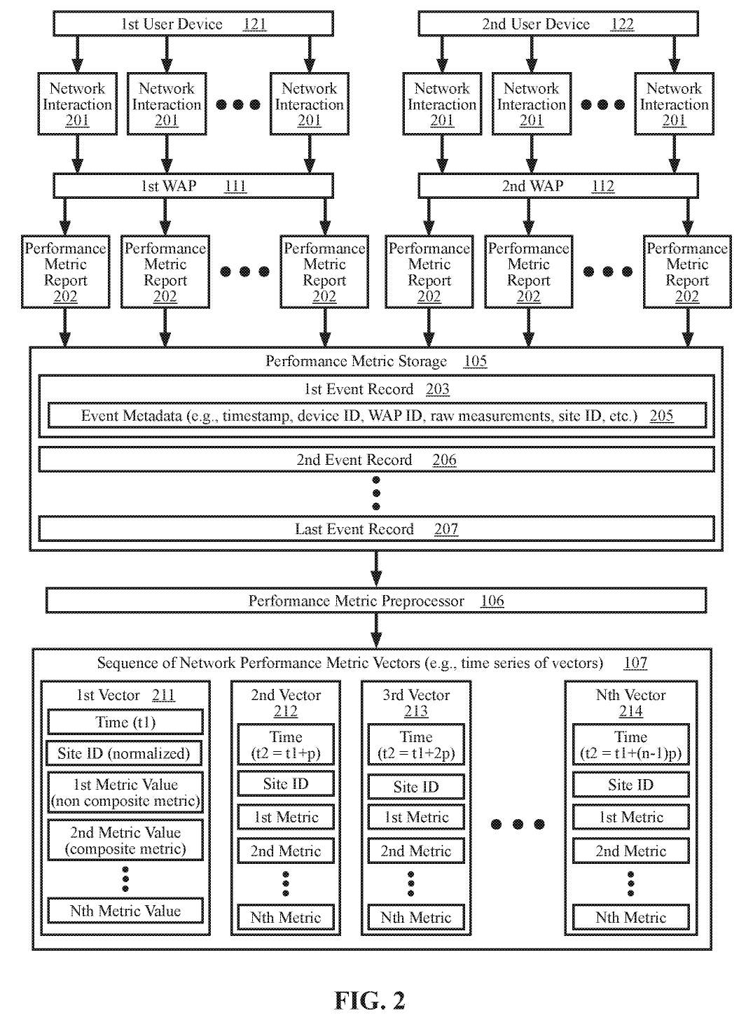

FIG. 2 is a high-level block diagram illustrating an example of gathering measurements from user devices to produce network performance metric vectors, according to some aspects. The user devices and the network devices (e.g., the WAPs) communicate via a series of network interactions 201. The network devices may use the network interactions 201 to produce measurements corresponding to various network performance metrics. Those practiced in the art are familiar with gathering such measurements. In an example, the network devices may be configured to automatically send performance metric reports 202 that include the measurements. In another example, the network devices are polled to obtain the performance metric reports 202. The example illustrated in FIG. 2 shows the performance metric storage 105 storing the measurements in event records such as a first event record 203, a second event record 206, and a last event record 207. An event record can include event metadata 205 that includes data received in a performance metric report (e.g., timestamp, device ID, WAP ID, raw measurements, site ID, etc.).

In an example, the performance metric preprocessor 106 uses the data in the event records to produce a sequence of network performance metric vectors 107 that includes a first network performance metric vector 211, a second network performance metric vector 212, a third network performance metric vector 213, and a last network performance metric vector 214. Each network performance metric vector can include a timestamp, a site identifier, and values corresponding to network performance metrics (e.g., first metric value, second metric value, etc.). The metrics can be values corresponding to network performance metrics. The network performance metrics can include composite metrics and non-composite metrics. A non-composite metric may be a measurement received from a network device. A composite metric is a metric that is produced from the performance metrics of numerous network devices. An example of a composite network performance metric is the number of successful WiFi association requests within the network that may be determined by summing the number of successful WiFi association requests of each WiFi access point. An example of a non-composite network performance metric is the number of successful WiFi association requests for a specific WiFi access point.

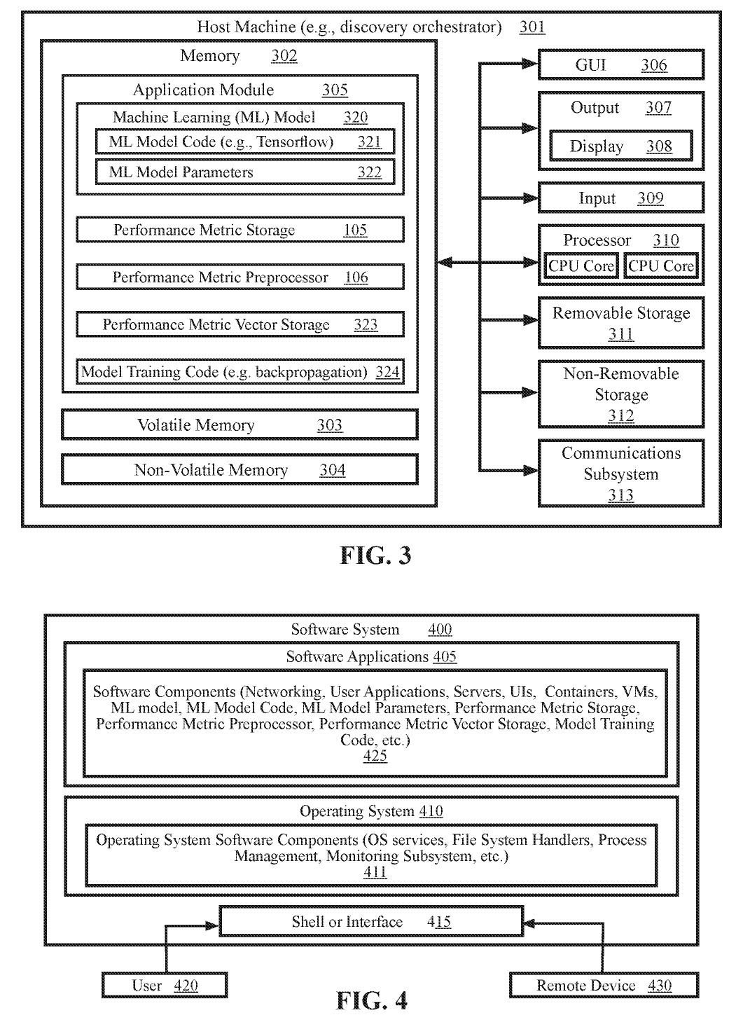

FIG. 3 is a high-level block diagram illustrating an example of a host machine 301 that may detect abnormal network behavior, according to some aspects. The host machine 301 may be the cloud server 102. The example illustrated in FIG. 3 shows a computing device in the form of a host machine 301 that can interface with controllers, peripheral devices, and other elements. The host machine 301 includes one or more processing units 310 coupled to memory 302, removable storage 311, and non-removable storage 312. Memory 302 may include volatile memory 303 and non-volatile memory 304. Host machine 301 may include or have access to a computing environment that includes a variety of transitory and non-transitory computer storage media such as volatile memory 303 and non-volatile memory 304, removable storage 311 and non-removable storage 312. Examples of a computer storage medium include random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions and data. Of the listed computer storage media, volatile memory, and most RAM, such as dynamic RAM (DRAM), are transitory computer storage media while the others are considered non-transitory computer storage media.

Host machine 301 may include, or have access to, a computing environment that includes input 309, output 307, and a communications subsystem 313. The host machine 301 may operate in a networked environment using the communications subsystem 313 to connect to one or more remote computers, remote sensors and/or controllers, detection devices, hand-held devices, multi-function devices (MFDs), speakers, mobile devices, tablet devices, mobile phones, wireless access points, smartphones, or other such devices. The remote computer may also be a personal computer (PC), server, router, network PC, radio frequency identification (RFID) enabled device, a peer device or other common network node, etc. The communication connection may connect to a local area network (LAN), a wide area network (WAN), wireless network, Bluetooth connection, or other networks.

Output 307 may be provided as a computer monitor or flat panel display but may include any output device. Output 307 and/or input 309 may include a data collection apparatus associated with host machine 301. In addition, input 309, which may include a computer keyboard, a pointing device such as a computer mouse, computer trackpad, or touch screen allows a user to instruct host machine 301. A user interface can be provided using output 307 and input 309. Output 307 may include a display 308 for displaying data and information for a user, or for interactively displaying a graphical user interface (GUI) 306. A GUI is typically responsive to user inputs entered through input 309 and typically displays images and data on display 308.

Note that the term "GUI" generally refers to a type of environment that represents programs, files, options, and so forth by means of graphically displayed icons, menus, and dialog boxes on a computer monitor screen or smartphone screen. A user can interact with the GUI to select and activate such options by directly touching the screen and/or pointing and clicking with a user input device 309 such as, for example, a pointing device such as a mouse, and/or with a keyboard. A particular item can function in the same manner to the user in all applications because the GUI provides standard software routines (e.g., the application module 305 can include program code in executable instructions, including such software routines) to handle these elements and report the user's actions.

Computer-readable instructions (e.g., program code in application module 305), can include or be representative of software routines, software subroutines, software objects, etc. described herein, are stored on a computer-readable medium (e.g., non-transitory computer storage media or transitory computer storage media) and are executable by the processor device (also called a processing unit) 310 of host machine 301. The application module 305 may include computer code and data including, for example, a machine learning model 320, performance network storage 105, the performance metric preprocessor 106, performance metric vector storage 323, and model training code 324. The machine learning model can include ML model code 321. In an example, the ML model code is python language code that uses the Tensorflow library to implement an encoder-decoder model such as a transformer. Other ML libraries such as pytorch and keras may alternatively or in addition be used. Keras, Tensorflow, and pytorch are well known by those practiced in the art of ML. The machine learning model 320 includes ML model parameters 322. Those practices in the art of ML know of numerous code and data repositories (e.g., github.com, huggingface.co, etc.) from which ML model code and ML model parameters may be obtained and then used to implement a ML model on a computer such as host machine 301. The ML model in the example is configured to produce a predicted mean vector and a variance vector in response to receiving a sequence of network performance metric vectors. The performance metric preprocessor 106 may use the data stored in performance metric storage 105 to produce network performance metric vectors (e.g., first vector 211) and the network performance metric vectors may be stored in performance metric vector storage 323. As such, previously computed vectors are available for later use. Model training code 324 may be used to train the machine learning model. Training the ML model typically includes providing the ML model with inputs to thereby obtain an output from the ML model. A loss function may produce an error, often called the loss, by comparing the output to a desired output. The loss may be used to adjust the ML model parameters in order to minimize the loss. The ML libraries include implementations of algorithms, such as backpropagation, that adjust the ML model parameters based on the loss. The computer code may read, write, or modify data. A hard drive, CD-ROM, RAM, flash memory, and a USB drive are just some examples of a computer storage medium. Sequences of network performance metric vectors such as those stored in performance metric vector storage 323 may be used to train the ML model 320.

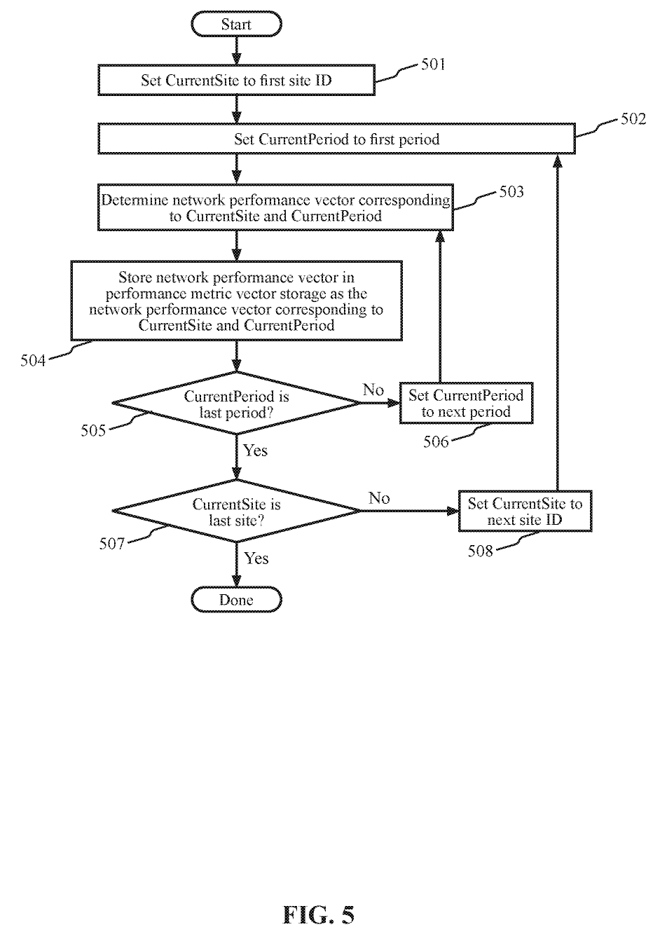

FIG. 4 is a high-level block diagram illustrating an example of a software system 400 according to some aspects. The software system 400 may be employed for directing the operation of data-processing systems such as host machine 301. Software applications 405 may be stored in memory 302, on removable storage 311 or on non-removable storage 312, and generally includes and/or is associated with an operating system 410 and a shell or interface 415. One or more application programs may be "loaded" (i.e., transferred from removable storage 311 or non-removable storage 312 into the memory 302) for execution by the host machine 301. Application programs 405 can include software components 425 such as software modules, software subroutines, software objects, network code, user application code, server code, UI code, container code, virtual machine (VM) code, ML model, ML model code, ML model parameters, performance metric storage, performance metric preprocessor, performance metric vector storage, model training code, etc. The software system 400 can have multiple software applications each containing software components. The host machine 301 can receive user commands and data through interface 415, which can include input 309, output 307, and communications connection 313 accessible by a user 420 or remote device 430. These inputs may then be acted upon by the host machine 301 in accordance with instructions from operating system 410 and/or software applications 405 and any software components 425 thereof. The operating system may include operating system software components 411 such as operating system services, file system handlers, process management, monitoring subsystem, etc.

Software components 425 can include, but are not limited to, routines, subroutines, software applications, programs, modules, objects (used in object-oriented programs), executable instructions, data structures, etc., that perform specific tasks or implement specific abstract data types and instructions. Moreover, those skilled in the art will appreciate that elements of the disclosed methods and systems may be practiced with other computer system configurations such as, for example, hand-held devices, mobile phones, smartphones, tablet devices, multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, etc.

Note that the terms "component" and “module” as utilized herein may refer to one of or a collection of routines and data structures that perform a particular task or implement a particular data type. Applications and components may be composed of two parts: an interface, which lists the constants, data types, variables, and routines that can be accessed by other modules or routines; and an implementation, which is typically private (accessible only from within the application or component) and which includes source code that implements the routines in the application or component. The terms application or component may also simply refer to an application such as a computer program designed to assist in the performance of a specific task such as word processing, accounting, etc. Components can be built or realized as special purpose hardware components designed to equivalently assist in the performance of a task.

The interface 415 can include a graphical user interface 306 that may display results, whereupon a user 420 or remote device 430 may supply additional inputs or terminate a particular session. In some examples, operating system 410 and GUI 306 can be implemented in the context of a "windows" system. It can be appreciated, of course, that other types of systems are possible. For example, rather than a traditional "windows" system, other operating systems such as, for example, a real time operating system (RTOS) more commonly employed in wireless systems may also be employed with respect to operating system 410 and interface 415. The software application 405 can include, for example, software components 425 that may include instructions for carrying out steps or logical operations such as those shown and described herein.

The description herein is presented with respect to examples that may be implemented in the context of, or require the use of, a data processing system such as host machine 301, in conjunction with program code in an application module 305 in memory 302, software system 400, or host machine 301. The disclosed examples, however, are not limited to any specific application or environment. Instead, those skilled in the art will find that the systems and methods described herein may be advantageously applied to a variety of system and application software including database management systems, word processors, etc. Moreover, the examples may be implemented on a variety of different platforms including Windows, Macintosh, UNIX, LINUX, Android, Arduino, etc. Therefore, the descriptions of the examples which follow are for purposes of illustration and not considered a limitation.

Host machines 301 and software systems 400 can take the form of or run as virtual machines (VMs) or containers that run on physical machines. A VM or container typically supplies an operating environment, appearing to be an operating system, to program code in an application module and software applications 405 running in the VM or container. A single physical computer can run a collection of VMs and containers. In fact, an entire network data processing system including a multitude of host machines 301, LANs and perhaps even WANs or portions thereof can all be virtualized and running within a single computer (or a few computers) running VMs or containers. Those practiced in cloud computing are practiced in the use of VMs, containers, virtualized networks, and related technologies.

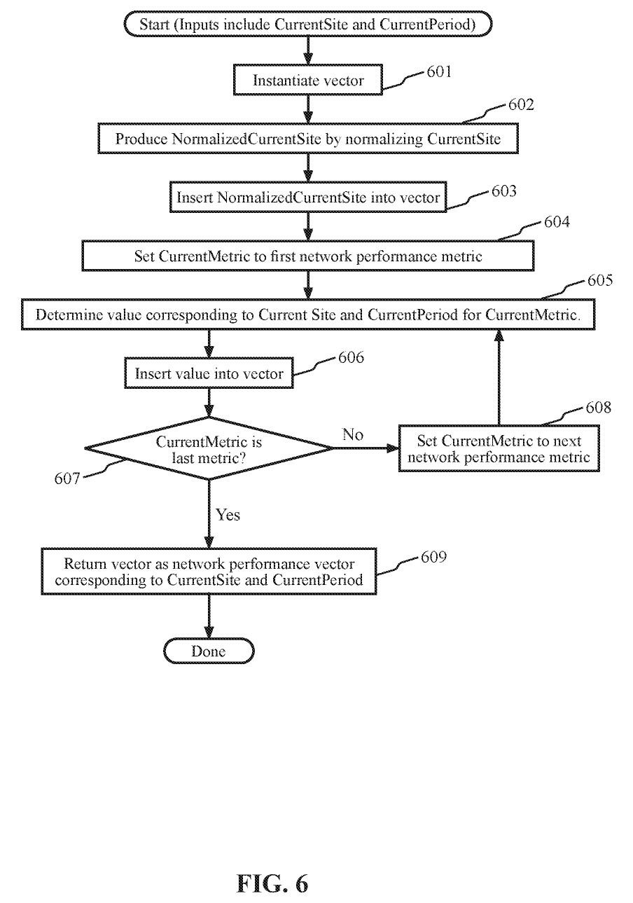

FIG. 5 is a high-level flow diagram illustrating an example of producing and storing network training vectors corresponding to numerous sites and time periods, according to some aspects. Cloud server 102 or host machine 301 may implement the process illustrated in FIG. 5. At block 501, currentSite (a process variable) is set to indicate a first site. For example, the sites can be the client sites being monitored using cloud server 102 and the first site can be the first one of those sites. At block 502, currentPeriod (a process variable) is set to indicate a first period. The process illustrated in FIG. 5 can generate a sequence of network performance metric vectors corresponding to a sequence of time periods for each of the client sites that are being monitored. The first period is the first time period in that sequence of time periods. At block 503, the network performance metric vector corresponding to currentPeriod and currentSite is determined (see, e.g., FIG. 6). At block 504, the network performance metric vector is stored in performance metric vector storage 323 as the network performance metric vector corresponding to currentSite and currentPeriod. At decision block 505, currentPeriod is compared to the last period in the sequence of time periods. The process moves to decision block 507 if currentPeriod is the last period in the sequence of time periods at decision block 505. Otherwise, the process moves to block 506. At block 506, currentPeriod is set to the next period in the sequence of time periods before the process loops back to block 503. At decision block 507, currentSite is compared to the last site. The process is done if currentSite is the last site at decision block 507. Otherwise, the process moves to block 508. At block 508, currentSite is set to indicate the next site before the process loops back to block 502.

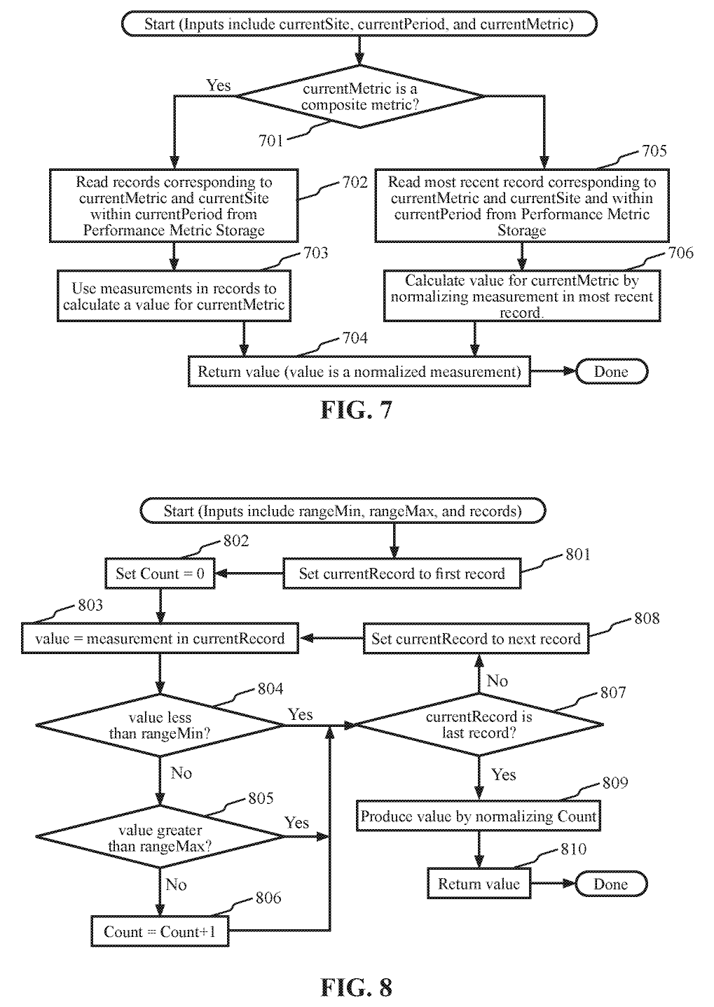

FIG. 6 is a high-level flow diagram illustrating an example of producing a network training vector corresponding to a client site and a time period, according to some aspects. Cloud server 102 or host machine 301 may implement the process illustrated in FIG. 6. The process variables currentSite and currentPeriod indicate a site and a time period. For example, currentSite and currentPeriod may be set by the process shown in FIG. 5. At block 601, a vector is instantiated. This vector will become a network performance metric vector. At block 602, normalizedSite (a process variable) is produced by normalizing currentSite. For example, currentSite may be an integer that identifies a client site. NormalizedSite may be produced by a mapping that maps those integers into the range 0-1. As is known in machine learning, normalizing the values input to a ML model often results in better performance. At block 603, NormalizedSite is inserted into the vector (see, e.g., the "Site ID" element in first vector 211 which is shown in FIG. 2). At block 604, currentMetric is set to indicate the first network performance metric in a set of network performance metrics. The network performance metric vector will be populated with values corresponding to a set of network performance metrics beginning with the first network performance metric and ending with the last network performance metric. At block 605, the value corresponding to currentSite and currentPeriod for currentMetric is determined (see, e.g., FIG. 7). At block 606, the value is inserted into the vector (see, e.g., "1st Metric Value" in first vector 211 which is shown in FIG. 2). At decision block 607, currentMetric is compared to the last network performance metric in the set of network performance metrics. The process moves to block 609 if currentMetric is the last network performance metric in the set of network performance metrics at decision block 607. Otherwise, the process moves to block 608. At block 608, currentMetric is set to the next network performance metric in the set of network performance metrics before the process loops back to block 605. At block 609, the vector is returned as the network performance metric vector corresponding to currentSite and currentPeriod before the process is done.

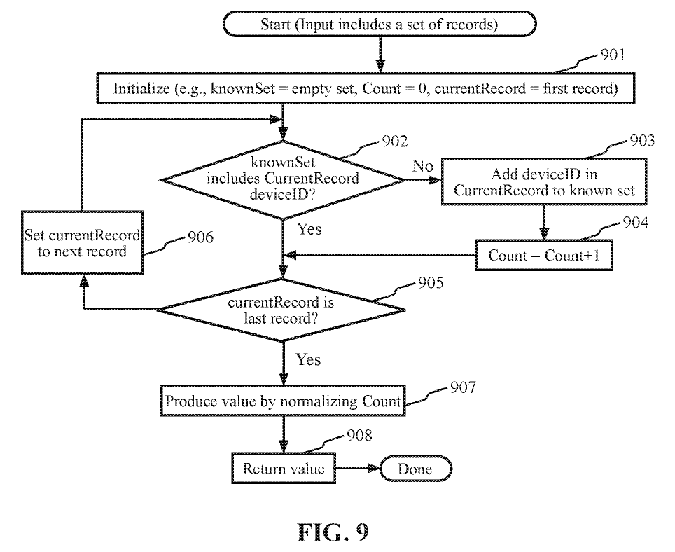

FIG. 7 is a high-level flow diagram illustrating an example of producing a value for a network performance metric corresponding to a client site and a time period, according to some aspects. Cloud server 102 or host machine 301 may implement the process illustrated in FIG. 7. The process variables currentSite, currentPeriod, and currentMetric indicate a site, a time period, and a network performance metric. For example, currentSite, currentPeriod, and currentMetric may be set by the processes shown in FIGS. 5 and 6. At decision block 701, currentMetric is checked to see if it is a composite metric. The process moves to block 702 if currentMetric is a composite metric at decision block 701. Otherwise, the process moves to block 705. At block 702, records corresponding to currentMetric and currentSite within currentPeriod are read from performance metric storage 105. In an example, the records in performance metric storage 105 are searchable by time and date range and are indexed by Site ID and by metric, thereby providing for rapid searches for records within a period specified by currentPeriod and having Site ID = currentSite and metric = currentMetric. At block 703, the measurements in the records are used to calculate a value for currentMetric (see, e.g., FIGS. 8 and 9). At block 704, the value calculated at block 703 or at block 706 is returned before the process is done. At block 705, the most recent record corresponding to currentMetric and currentSite and within currentPeriod is read from performance metric storage 105. At block 706, a value for currentMetric is calculated by normalizing the measurement in the record read in block 705.

FIG. 8 is a high-level flow diagram illustrating an example of producing a range count indicator from a set of records, according to some aspects. The range count indicator may be a scaled count corresponding to a counted metric. Cloud server 102 or host machine 301 may implement the process illustrated in FIG. 8. The process counts the number of records for which a value is within a range specified by rangeMin (a process variable) and rangeMax (a process variable). The records can be the set of records read at block 702 of FIG. 7. At block 801, currentRecord (a process variable) is set to the first record in the set of records. At block 802, Count (a process variable) is set to zero. At block 803, value (a process variable) is set to equal the measurement in currentRecord. At decision block 804, value is compared to rangeMin. The process moves to decision block 807 if value is less than rangeMin is at decision block 804. Otherwise, the process moves to decision block 805. At decision block 805, value is compared to rangeMax. The process moves to decision block 807 if value is greater than rangeMax at decision block 805. Otherwise, the process moves to block 806. At block 806, Count is incremented by 1. At decision block 807, currentRecord is compared to the last record in the set of records. The process moves to block 809 if currentRecord is the last record in the set of records at decision block 807. Otherwise, the process moves to block 808. At block 808, currentRecord is set to the next record in the set of records. At block 809, value (a process variable) is produced by normalizing Count. As discussed above, inputs to a ML model are often normalized to a range such as 0 to 1 or -1 to 1. At block 810, value is returned before the process is done.

FIG. 9 is a high-level flow diagram illustrating an example of producing an event count indicator from a set of records, according to some aspects. Cloud server 102 or host machine 301 may implement the process illustrated in FIG. 9. Here, the event count indicator corresponds to the number of user devices appearing at least once in the set of records. The event count indicator may be a scaled count (e.g., a normalized value) corresponding to a counted metric. Inputs to the process include a set of records such as the set of records read at block 702 of FIG. 7. At block 901, various process variables are initialized such that knownSet indicates an empty set, Count=0, and currentRecord is the first record in the set of records. The record currentRecord includes a field for deviceID which identifies a specific device such as a network device, a user device, etc. At decision block 902, knownSet is checked to see if it already includes deviceID. The process moves to decision block 905 if knownSet includes deviceID at decision block 902. Otherwise, the process moves to block 903. At block 903, deviceID is added to knownSet. At block 904, Count is incremented by 1. Decision block 902, block 903, and block 904 ensure that each user device is counted no more than once. At decision block 905, currentRecord is compared to the last record in the set of records. The process moves to block 907 if currentRecord is the last record at decision block 905. Otherwise, the process moves to block 906. At block 906, currentRecord is set to the next record in the set of records before the process loops back to decision block 902. At block 907, value (a process variable) is produced by normalizing Count. At block 908, value is returned before the process is done.

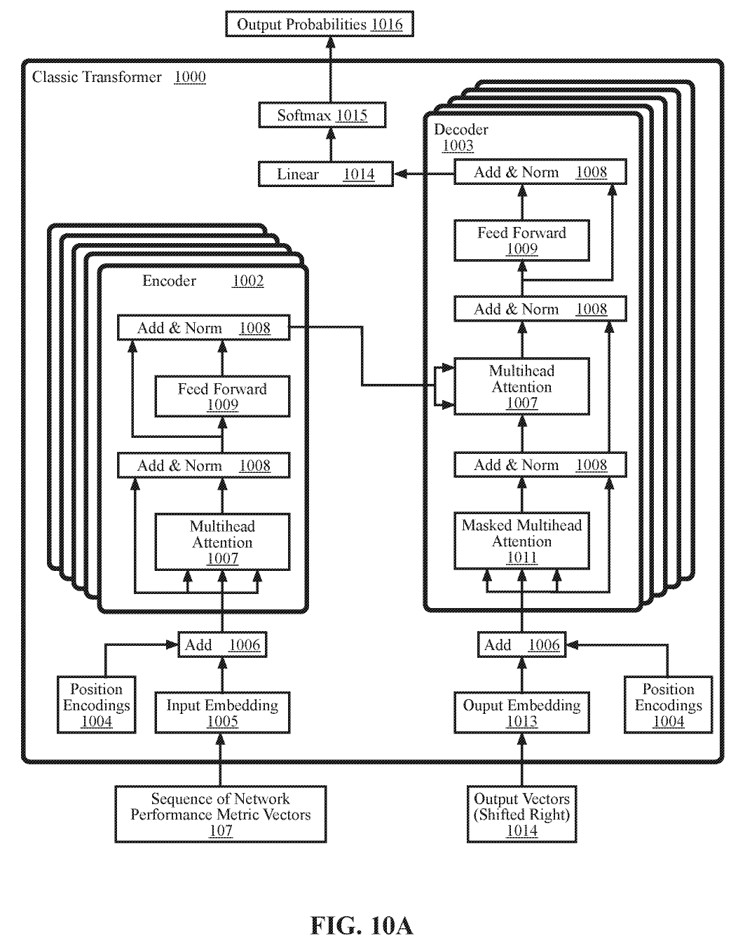

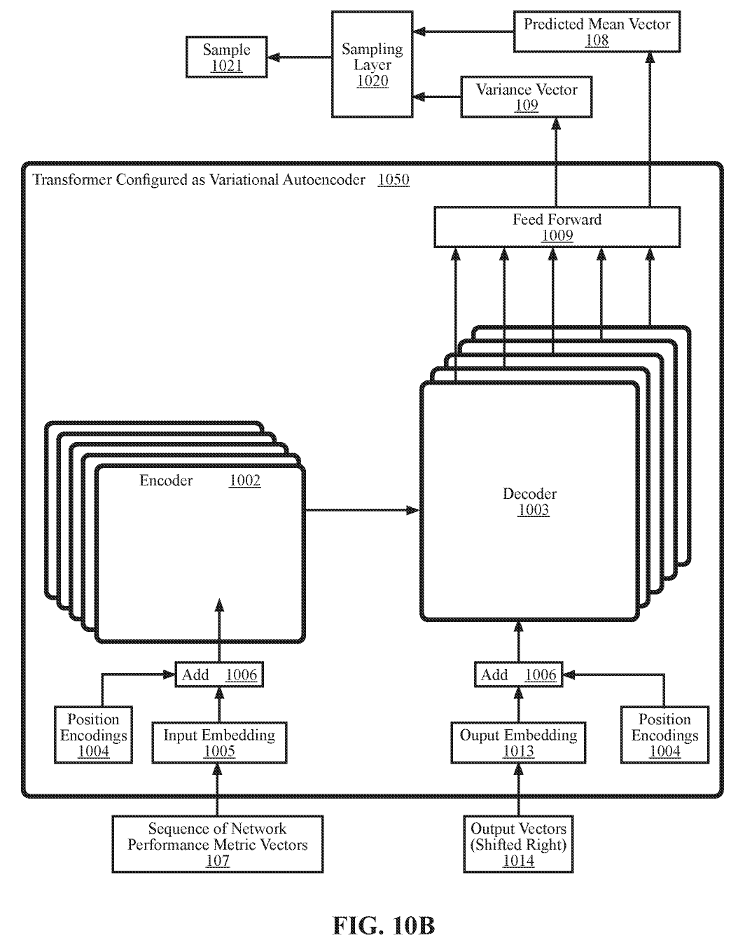

FIG. 10A is a high-level block diagram illustrating an example of a classic transformer 1000 configured to produce a vector of output probabilities 1016, according to some aspects. The transformer illustrated in FIG. 10 is based heavily on the transformer discussed in the paper: "Attention is All You Need" by Ashish Vaswani, Noam Shazeer, Niki Parmar, Jakob Uszkoreit, Llion Jones, Aidan N. Gomez, Lukasz Kaiser, and Illia Polosukhin, published in the proceedings of the Neural Information Processing Systems (NIPS) conference in 2017, hereinafter referred to as the Transformer Paper. The Transformer Paper is well known in the art of machine learning and is often considered required reading for ML students. As such, it is expected that those practiced in the art are familiar with position encodings such as position encodings 1004, adder block such as adder block 1006, multi-head attention blocks such as multi-head attention block 1007, add & normalize blocks such as add & normalize block 1008, feed forward networks such as feed forward network 1009, masked multi-head attention blocks such as masked multi-head attention block 1011, embeddings such as input embedding 1005 and output embedding 1013, encoders such as encoder 1002, decoders such as decoder 1003, learned linear transformations such as learned linear transformation 1014, and softmax functions such as softmax function 1015. Softmax 1015 produces output probabilities, which is the output of the transformer 1000.

The transformer 1000 includes an encoder 1002 and a decoder 1003. The transformer 1000 is therefore a machine learning model that is an encoder-decoder model. Input embedding 1005 calculates the embeddings for the sequence of network performance metric vectors 107. As is known in the art, an example of input embedding 1005 is a fully connected neural network that learns the embeddings while the model is trained. An adder block 1006 can add position encodings 1004 to the embeddings. In an example, position encodings are sinusoids as discussed in the Transformer Paper. Other examples can use other position encodings that are known in the art. The position encoded embeddings are passed to the encoder block which includes encoder 1002. Turning to the inputs of the decoder 1003, output embedding 1013 calculates the embeddings for a sequence of previously determined output vectors (e.g., previously determined predicted mean vectors such as predicted mean vector 108). As is known in the art, an example of output embedding 1013 is a fully connected neural network that learns the embeddings while the model is trained. An adder block 1006 can add position encodings 1004 to the embeddings. The position encoded embeddings are passed to the decoder block which includes decoder 1003.

As is known in the art, a transformer may have numerous encoders in an encoder block and numerous decoders in a decoder block. As such, the encoder block is shown as a stack of encoders, and the decoder block is shown as a stack of decoders. In many examples the encoders all have the same internal structure while having different weights and the decoders all have the same internal structure while having different weights.

The position coded input embeddings are input to the encoder's multi-head attention block 1007. The output of the encoder's multi-head attention block 1007 and the position coded input embeddings are input to the encoder's first add & normalize block 1008. The output of the encoder's first add & normalize block 1008 are input to the encoder's feed forward network 1009. The output of the encoder's feed forward network 1009 and the position coded input embeddings are input to the encoder's second add & normalize block 1008. The output of the encoder's second add & normalize block 1008 is passed from the encoder 1002 to the decoder's multi-head attention block 1007.

The position coded output embeddings are input to the decoder's masked multi-head attention block 1011. The output of the decoder's masked multi-head attention block 1011 and the position coded output embeddings are input to the decoder's first add & normalize block 1008. The output of the encoder's second add & normalize block 1008 and the output of the decoder's first add & normalize block 1008 are passed to the decoder's multi-head attention block 1007. The output of the decoder's multi-head attention block 1007 and the output of the decoder's first add & normalize block 1008 are passed to the decoder's second add & normalize block 1008. The output of the decoder's second add & normalize block 1008 are input to the decoder's feed forward network 1009. The output of the decoder's feed forward network 1009 and the output of the decoder's second add & normalize block 1008 are input to the decoder's third add & normalize block 1008. The output of the decoder's third add & normalize block 1008 is passed from the decoder 1003 to the learned linear transformation 1014. The softmax function 1015 produces the output probabilities in response to receiving the output of the learned linear transformation 1014.

FIG. 10B illustrates an example of a transformer 1050 configured as a variational autoencoder that produces a predicted mean vector 108 and a variance vector 109, according to some aspects. The outputs of the decoders pass into a feed forward network 1009 that produces the predicted mean vector 108 and the variance vector 109 in response to receiving the decoder outputs. In an example, all the feed forward networks, including the feed forward network that produces the predicted mean vector 108 and the variance vector 109, are trained via backpropagation. The sampling layer 1020 produces a sample 1021 in response to receiving the predicted mean vector 108 and the variance vector 109. In an example, the sampling layer randomly generates a sample 1021 from a population centered at the predicted mean vector 108 and having the variance indicated by the variance vector 109. Those practiced in the art know various ways to produce such a sample. In an example, random numbers generated by a uniform random number generator are mapped to a normal distribution then shifted and scaled to thereby produce the elements of the sample 1021. Note that the sample can have the same dimensionality as the predicted mean vector 108 and the variance vector 109. The transformer 1050 implements a deterministic autoencoder when the predicted mean vector 108 is used as the model output (e.g., for the output vectors 1014). The transformer 1050 implements a variational autoencoder when the sample 1021 is used as the model output (e.g., for the output vectors 1014).

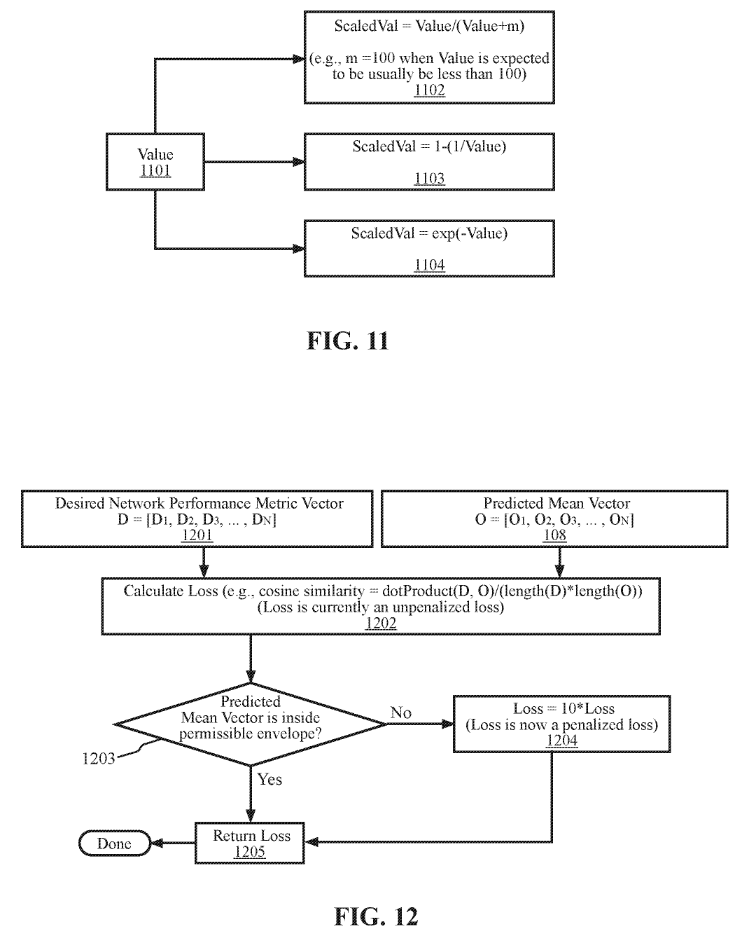

FIG. 11 is a high-level block diagram illustrating examples of functions that may be used for normalizing values in a network performance metric vector, according to some aspects. Value 1101 is to be normalized by calculating a scaled value, ScaledVal. ScaledVal is the normalized Value 1101. At block 1102, the ScaledVal = Value/(Value+m). In an example, good results were obtained by setting m=100. In other examples, m may be set to a number that is expected to be larger than Value 1101 most, but not all, of the time. The function used in block 1102 is good for normalizing counted metrics because it equals 0 when Value equals 0 and asymptotically approaches 1 as Value approaches infinity. At block 1103, the ScaledVal = 1-(1/Value). Note that ScaledVal is set to 0 when Value=0 to avoid division by zero. The function used in block 1103 is good for normalizing counted metrics because it equals 0 when Value equals 0 and asymptotically approaches 1 as Value approaches infinity. At block 1104, the function ScaledVal = exp(-Value). The function used in block 1104 is good for normalizing counted metrics because it equals 1 when Value equals 0 and asymptotically approaches 0 as Value approaches infinity. Other functions may be used for normalizing values.

FIG. 12 is a high-level block diagram illustrating an example of calculating a loss that represents a distance between the candidate mean vector and a desired outcome, according to some aspects. Cloud server 102 or host machine 301 may implement the process illustrated in FIG. 12. Here, the loss is increased in response to determining that the distance is an impermissible distance. The ML model produces the predicted mean vector 108 in response to receiving a sequence of network performance metric vectors 107. During training, the network performance metric vector immediately following the sequence of network performance metric vectors 107 is known. The network performance metric vector immediately following the sequence of network performance metric vectors 107 is the desired network performance metric vector 1201. At block 1202, the loss, or error, between the predicted mean vector 108 and the desired network performance metric vector 1201 is calculated. At decision block 1203, the predicted mean vector is checked to see if it is within a permissible envelope. In an example, the predicted mean vector is outside the permissible envelope when the loss calculated at block 1202 is greater than a threshold value, thereby indicating that the predicted mean vector is an impermissible distance from the desired network performance metric vector 1201. The process moves to block 1205 if the predicted mean vector within the permissible envelope at decision block 1203 and otherwise moves to block 1204. At block 1204, the loss is multiplied by 10, thereby increasing the loss. The loss is now a penalized loss because the predicted mean vector is not inside permissible envelope. The penalized loss in this example is 10 times greater than the loss calculated at block 1202. At block 1205, the loss is returned before the process is done.

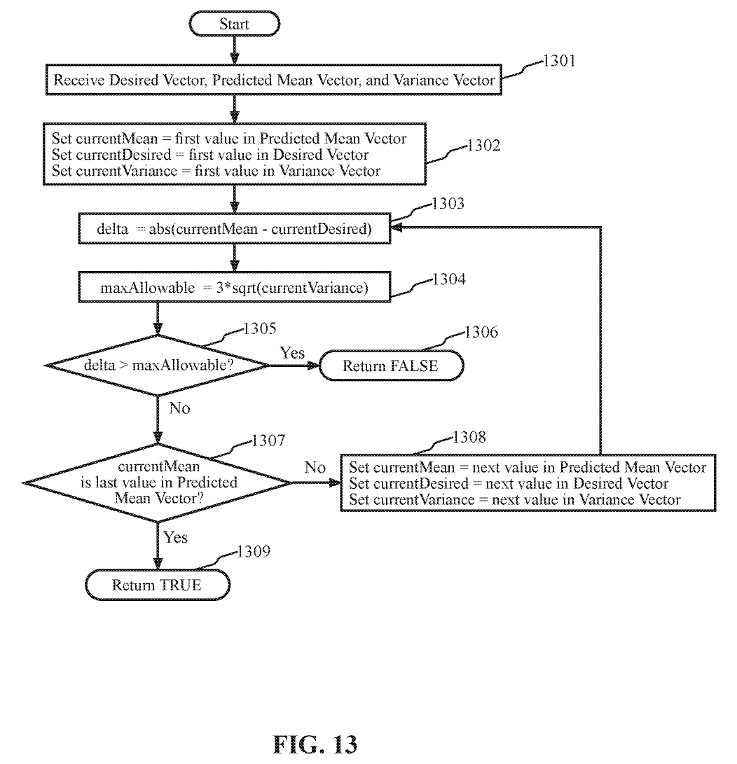

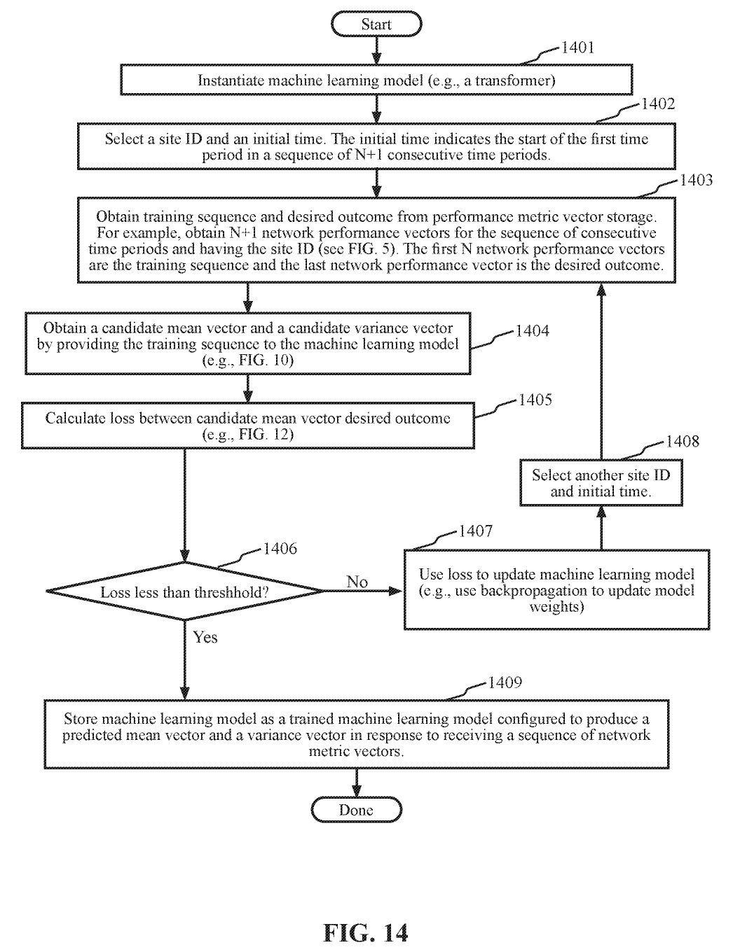

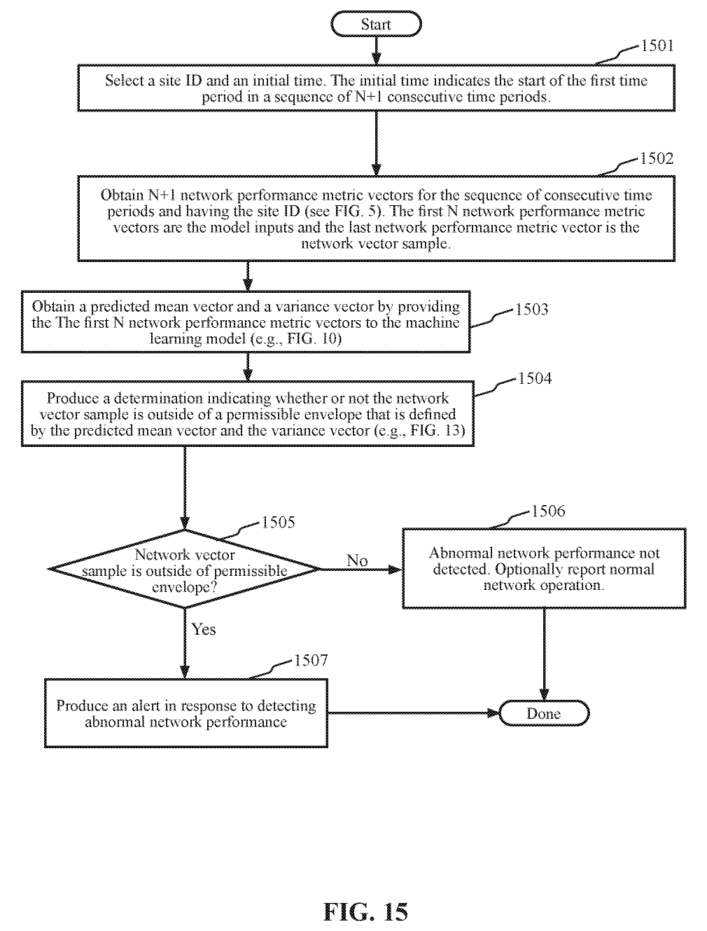

FIG. 13 is a high-level flow diagram illustrating an example of a process that determines that a predicted mean vector is an impermissible distance from a desired vector, according to some aspects. Cloud server 102 or host machine 301 may implement the process illustrated in FIG. 13. In training, the predicted mean vector may be called the candidate mean vector and the desired vector may be called the desired outcome. The predicted mean vector is outside the permissible envelope when it is an impermissible distance from a desired vector. At block 1301, the desired vector, predicted mean vector, and the variance vector are received. At block 1302, process variables are set by setting currentMean = first value in the predicted mean vector, setting currentDesired = first value in desired vector, and setting currentVariance = first value in variance vector. At block 1303, the distance, delta, between currentMean and currentDesired is calculated as delta = abs(currentMean - currentDesired). At block 1304, maxAllowable (a process variable) is calculated as maxAllowable = 3*sqrt(currentVariance). Here, maxAllowable is three times the standard deviation. At decision block 1305, delta is compared to maxAllowable. The process moves to block 1306 if delta is greater than maxAllowable at decision block 1305 and otherwise moves to decision block 1307. At block 1306, the process returns FALSE indicating that the predicted mean vector is not within the permissible envelope. The predicted mean vector is not within the permissible envelope because delta > maxAllowable indicates that the predicted mean vector is an impermissible distance from the desired vector. At decision block 1307, currentMean is checked to see if it is the last value in the predicted mean vector. The process moves to block 1309 if currentMean is the last value in the predicted mean vector at decision block 1307 and otherwise moves to block 1308. At block 1309, the process returns “TRUE” indicating that the predicted mean vector is a permissible distance from the desired vector. At block 1308, currentMean is set to the next value in the predicted mean vector, currentDesired is set to the next value in desired vector, and currentVariance is set to the next value in variance vector before the process loops back to block 1303. Note that the process illustrated in FIG. 13 may be used at decision block 1203 of FIG. 12.

In an example, the values in the variance vector are logarithms of the variance. Such logarithms may be used because the dynamic range of the variance can be tiny or huge. Those practiced in the art know how to calculate variances and standard deviations from log variances. Furthermore, the example used here for calculating a permissible distance (maxAllowable) is non-limiting and is presented as one example of using the variance vector to determine the permissible envelope.

FIG. 14 is a high-level flow diagram illustrating an example of training a machine learning model to produce a predicted mean vector and a variance vector in response to receiving a sequence of network performance metric vectors, according to some aspects. Cloud server 102 or host machine 301 may implement the process illustrated in FIG. 14. At block 1401, a machine learning model, such as a transformer, is instantiated. At block 1402, a site ID and an initial time are selected. The initial time indicates the start of the first time period in a sequence of N+1 consecutive time periods. At block 1403, a training sequence and a desired outcome are obtained from performance metric vector storage 323. In an example, the training sequence and a desired outcome are obtained by obtaining N+1 network performance vectors for the sequence of consecutive time periods and having the site ID (see FIG. 5). The first N network performance vectors are the training sequence, and the last network performance metric vector is the desired outcome. At block 1404, a candidate mean vector and a candidate variance vector are obtained by providing the training sequence to the machine learning model (e.g., FIG. 10). At block 1405, the loss between the candidate mean vector and the desired outcome is calculated (e.g., FIG. 12). At decision block 1406, the loss is compared to a threshold to determine if training the ML model is complete. The process moves to block 1409 if the loss is less than the threshold at decision block 1406 and otherwise moves to block 1407. At block 1407, the loss is used to update the ML model. For example, backpropagation can be used to update the model weights. At block 1408, another site ID and another initial time are selected before the process loops back to block 1403. At block 1409, the machine learning model is stored as a trained machine learning model configured to produce a predicted mean vector and a variance vector in response to receiving a sequence of network performance metric vectors. As is known in the art, the machine learning model is stored by writing its weights to nonvolatile memory.

FIG. 15 is a high-level flow diagram illustrating an example of using a machine learning model to produce an alert in response to detecting abnormal network performance, according to some aspects. Cloud server 102 or host machine 301 may implement the process illustrated in FIG. 15. At block 1501, a site ID and an initial time are selected. The initial time indicates the start of the first time period in a sequence of N+1 consecutive time periods. At block 1502, N+1 network performance metric vectors are obtained for the sequence of consecutive time periods and having the site ID (see FIG. 5). The first N network performance metric vectors are the model inputs, and the last network performance metric vector is the network vector sample. At block 1503, a predicted mean vector and a variance vector are obtained by providing the first N network performance metric vectors to the machine learning model (e.g., FIG. 10). At block 1504, a determination is produced that indicates whether or not the network vector sample is outside of a permissible envelope that is defined by the predicted mean vector and the variance vector (e.g., FIG. 13). At decision block 1505, the determination produced in block 1504 is checked. The process moves to block 1507 if the determination indicates that the sample is outside of the permissible envelope at decision block 1505 and otherwise moves to block 1506. Abnormal network performance is detected when the sample is outside of the permissible envelope, otherwise no abnormal network has been detected. At block 1507, an alert is produced in response to detecting abnormal network performance. The alert can be a message, notification, email, etc. that is sent to a network engineer or to some other entity that should be notified when abnormal network performance is detected. At block 1506, there has been no detection of abnormal network performance. As such, a message, notification, email, etc. may optionally be sent at block 1506 to a network engineer or to some other entity to report normal network operation.

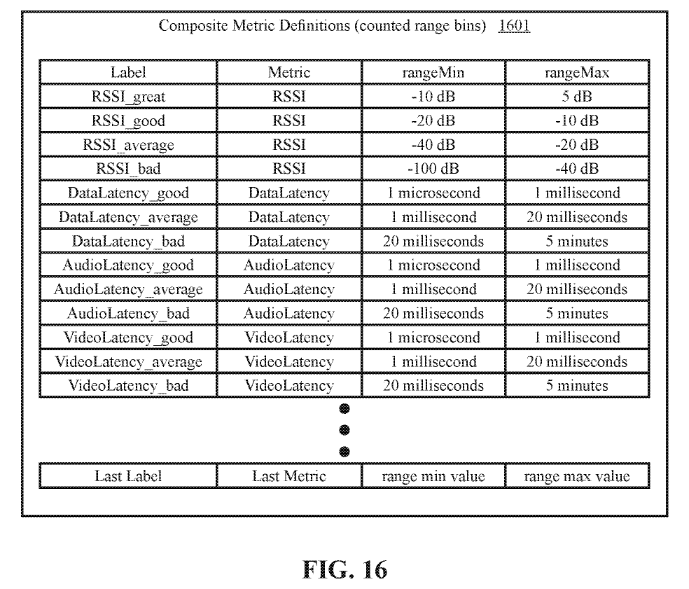

FIG. 16 is a high-level block diagram illustrating examples of composite metric definitions 1601 according to some aspects. The composite metric definitions 1601 define counted range bins for certain metrics. FIGS. 7 and 8 illustrate examples of processes that may use the composite metric definitions. The composite metric definitions provide specified ranges for certain composite metrics. More specifically, consider the "RSSI_great" composite metric that indicates the number of user devices in the "RSSI_great" range bin during a specific time period at the client site identified by siteID. the "RSSI_great" composite metric can be determined by setting currentSite = siteID, setting currentPeriod to the specific time period, and setting currentMetric to RSSI (the metric corresponding to "RSSI_great" in the composite metric definitions 1601) at the start of the process illustrated in FIG. 7. The process illustrated in FIG. 7 reads the appropriate records at block 702 and then at block 703 passes them to the process illustrated in FIG. 8 along with the rangeMin and rangeMax values corresponding to "RSSI_great" in the composite metric definitions 1601. The process illustrated in FIG. 8 thereby produces a value for the "RSSI_great" composite metric. The values for other composite metrics may be similarly calculated. The metric corresponding to "RSSI_great" is RSSI, an acronym for received signal strength indicator. As such, "RSSI_great" is an RSSI range count indicator. Similarly, “DataLatency_good” is a data latency range count indicator, “AudioLatency_good” is an audio latency range count indicator, and “VideoLatency_good” is a video latency range count indicator. Metrics such as data latency range count indicators, audio latency range count indicators, and video latency range count indicators are examples of latency range count indicators for different connection types (e.g., audio connections, video connections, data connections, etc.)

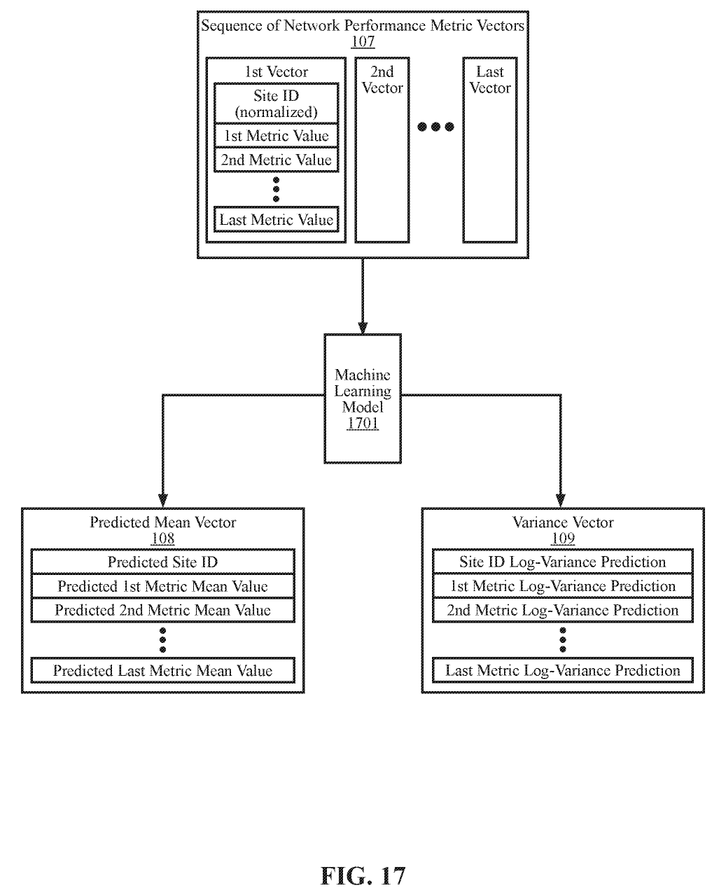

FIG. 17 is a high-level block diagram illustrating an example of a machine learning model 1701 producing a predicted mean vector and a variance vector in response to receiving a sequence of network performance metric vectors 107, according to some aspects. The predicted mean vector 108 includes a predicted Site ID and predicted mean values for a set of network performance metrics (e.g., predicted first metric mean value, predicted second metric mean value, and predicted last metric mean value). The variance vector 109 includes variance predictions, more specifically log-variance predictions where the variance predictions are presented as the logarithms of the predicted variance for each of the values in the predicted mean vector 108 (e.g., site ID variance prediction, first metric variance prediction, second metric variance prediction, and last metric variance prediction). In this example, the variances in variance vector 109 are represented by the logs of the predicted variances. Other examples may use the variance, may use the standard deviation to represent the variance, etc.

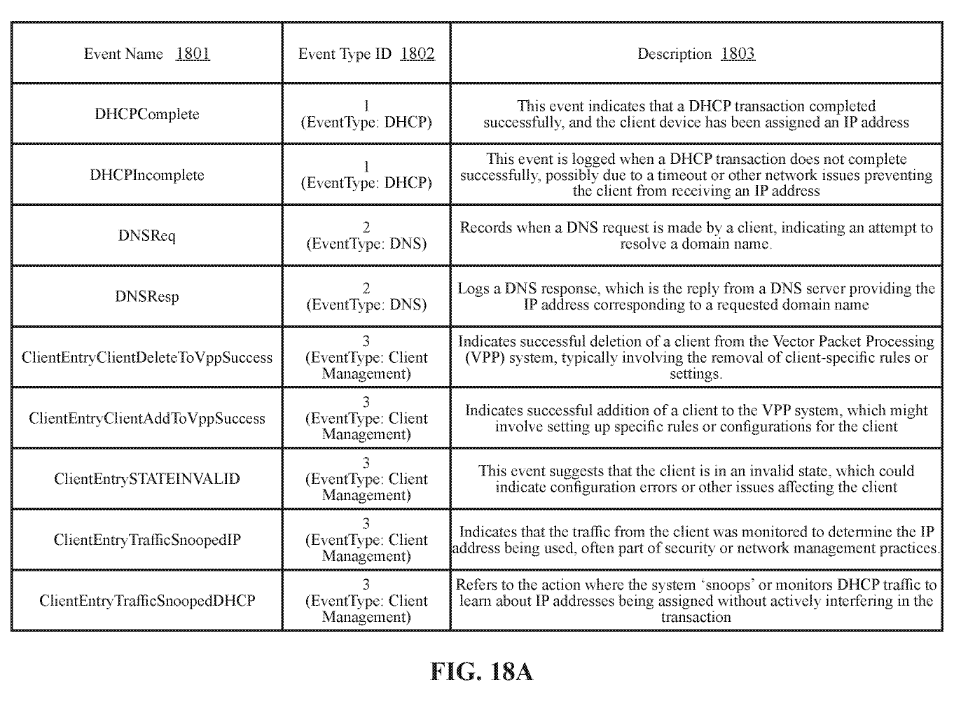

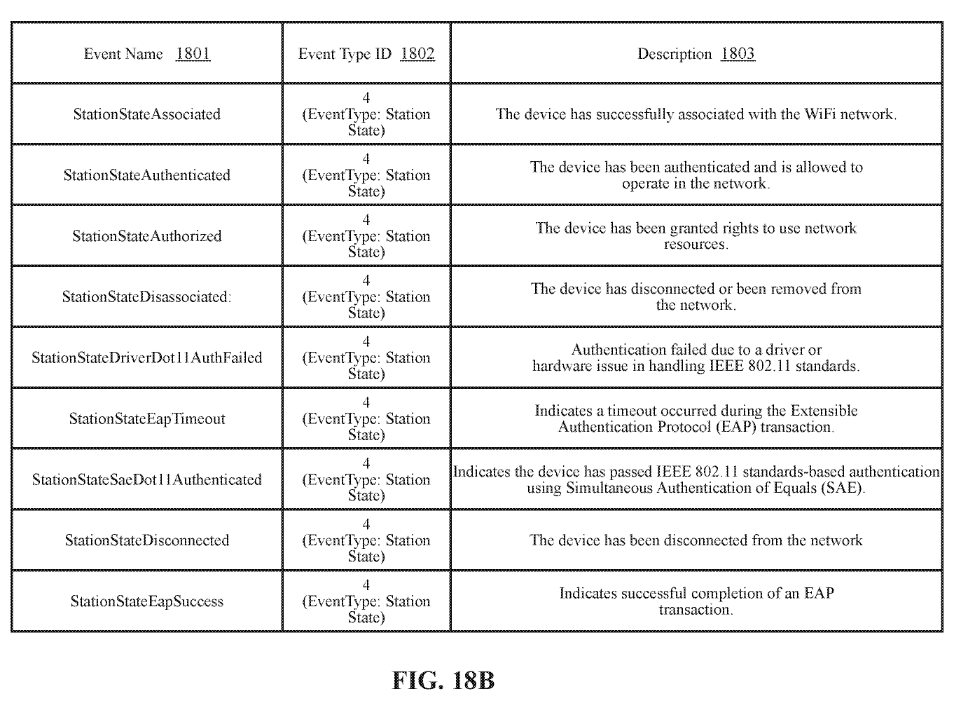

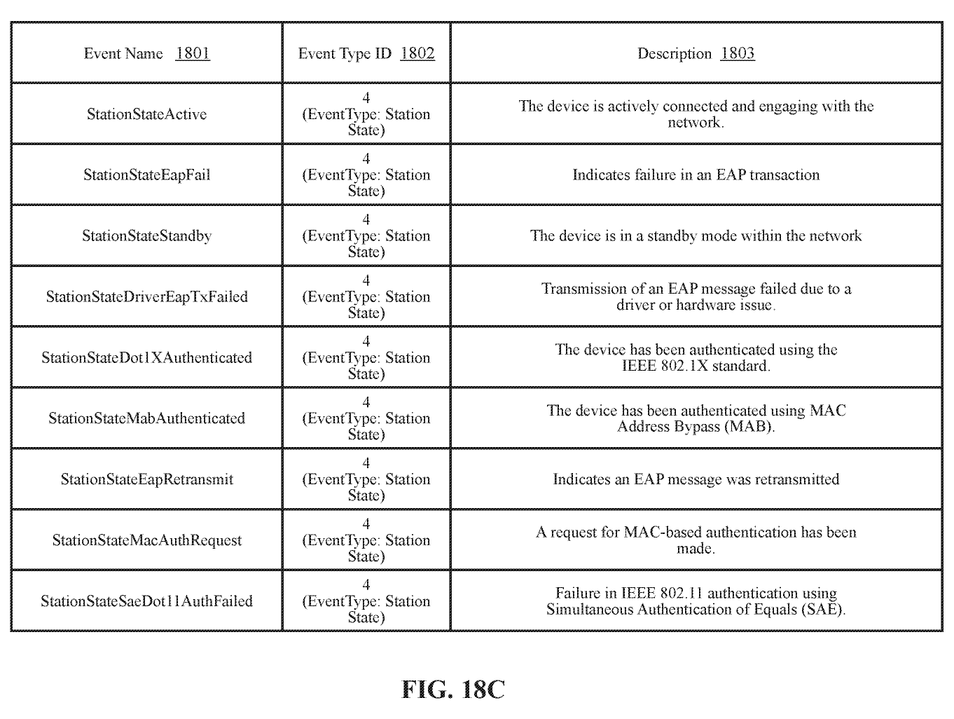

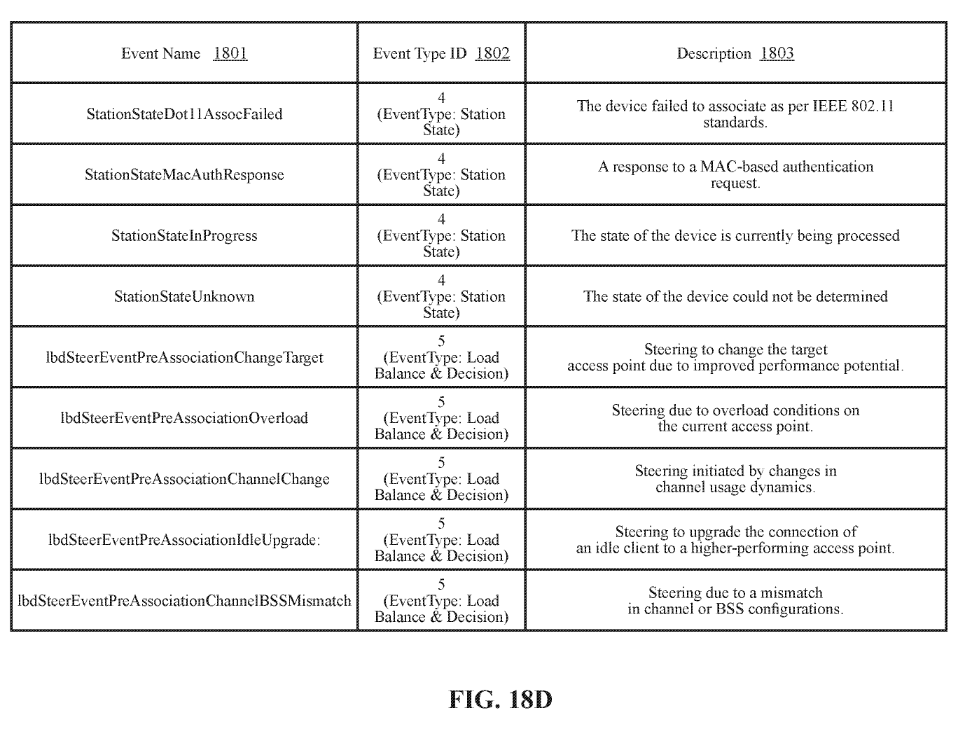

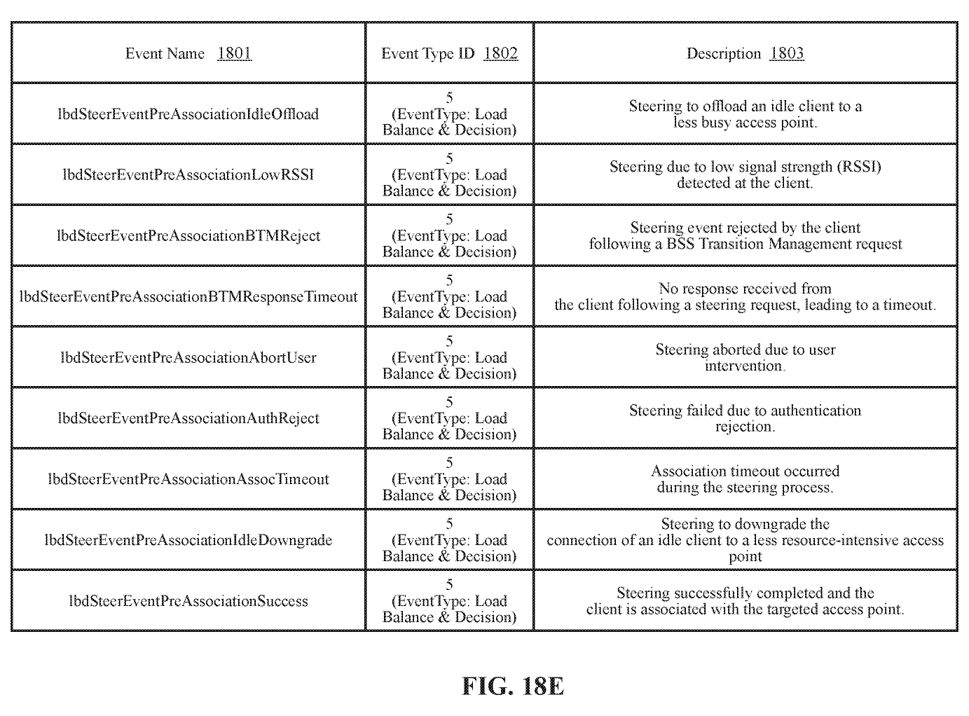

FIGS. 18A-18E are high-level conceptual diagrams illustrating an example of a table of events that may correspond to composite metrics that may be summed, according to some aspects. The table has three columns, an event name column 1801, an event type identifier column 1802, and a description column 1803. Each row provides a mapping from an event to an event type identifier. Events having the event name shown in event name column 1801 have the event type shown in the event type identifier column 1802. As is well understood by those practiced in network administration, the event metadata in an event record (e.g., event metadata in first event record 203 illustrated in FIG. 2) often includes the event name directly or includes other data that indicates the event name. In the example of FIG. 18, there are four event types. The number of event types and the mapping from event to event type identifier may vary in other examples.

The events listed in the table of events may be counted to thereby produce a composite metric. FIGS. 7 and 9 illustrate examples of processes that may count the events to produce a value for an event. More specifically, consider the DHCP event count indicators such as "DHCPComplete". “DHCPComplete” is a composite metric that indicates the number of DHCP completions for the user devices at a client site during a specific time period. The "DHCPComplete " composite metric can be determined by setting currentSite to the site ID of the client site, setting currentPeriod to the specific time period, and setting currentMetric to "DHCPComplete" at the start of the process illustrated in FIG. 7. The process illustrated in FIG. 7 reads the appropriate records at block 702 and then at block 703 passes them to the process illustrated in FIG. 9. The process illustrated in FIG. 9 thereby produces a value for the "DHCPComplete" composite metric. The values for other composite metrics may be similarly calculated. The event types may also correspond to composite metrics by counting the events within the event type. Events having the DHCP event type correspond to DHCP event count indicators. Events having the DNS event type correspond to DNS event count indicators. Events having the Client Management event type correspond to Client Management event count indicators. Events having the Station State event type correspond to Station State event count indicators. Events having the Load Balance & Decision event type correspond to Load Balance & Decision event count indicators.

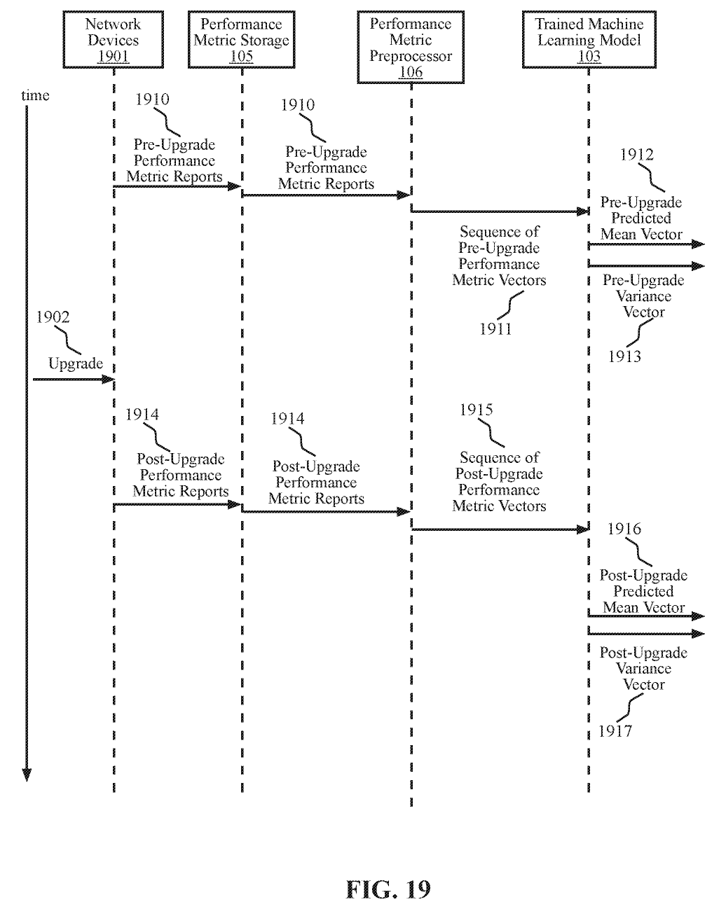

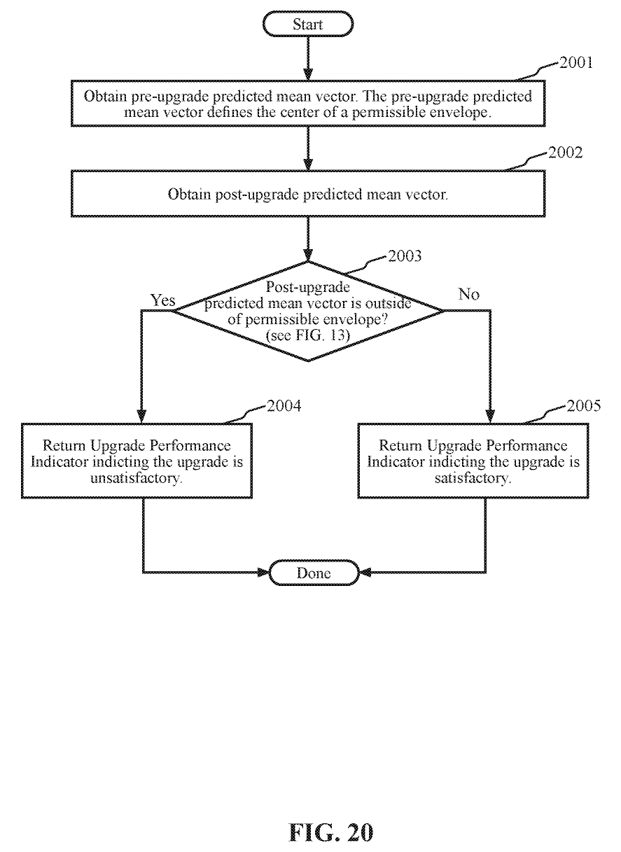

FIG. 19 is a high-level timing diagram illustrating an example of using a machine learning model to produce an alert in response to detecting abnormal network performance after an upgrade, according to some aspects. Network devices 1901 send pre-upgrade performance metric reports 1910 to performance metric storage 105. The performance metric preprocessor 106 reads the pre-upgrade performance metric reports 1910 from the performance metric storage 105 and uses them to produce a sequence of pre-upgrade performance metric vectors 1911 that are provided to the trained machine learning model 103. The trained machine learning model 103 produces a pre-upgrade predicted mean vector 1912 and a pre-upgrade variance vector 1913 in response to receiving the sequence of pre-upgrade performance metric vectors 1911. An upgrade 1902 is then performed. In an example, one or more of the network devices are upgraded to new versions of operating software. In another example one or more of the network devices are replaced with new or alternative network devices. After the upgrade, the network devices 1901 send post-upgrade performance metric reports 1914 to performance metric storage 105. The performance metric preprocessor 106 reads the post-upgrade performance metric reports 1914 from the performance metric storage 105 and uses them to produce a sequence of post-upgrade performance metric vectors 1915 that are provided to the trained machine learning model 103. The trained machine learning model 103 produces a post-upgrade predicted mean vector 1916 and a post-upgrade variance vector 1917 in response to receiving the sequence of post-upgrade performance metric vectors 1915. The pre-upgrade predicted mean vector 1912, the post-upgrade predicted mean vector 1916, and one of the variance vectors (e.g., pre-upgrade variance vector 1913 or post-upgrade variance vector 1917) may be used to determine whether the post-upgrade predicted mean vector 1916 is within a permissible envelope centered on the pre-upgrade predicted mean vector 1912. Note that this is equivalent to determining whether the pre-upgrade predicted mean vector 1912 is within a permissible envelope centered on the post-upgrade predicted mean vector 1916.

FIG. 20 is a high-level flow diagram illustrating an example of using a machine learning model to produce an alert in response to detecting abnormal network performance after an upgrade, according to some aspects. Cloud server 102 or host machine 301 may implement the process illustrated in FIG. 20. At block 2001, a pre-upgrade predicted mean vector is obtained. The pre-upgrade predicted mean vector defines the center of a permissible envelope. At block 2002, a post-upgrade predicted mean vector is obtained. At decision block 2003, the post-upgrade predicted mean vector is compared to the permissible envelope. The process moves to block 2004 if the post-upgrade predicted mean vector is outside the permissible envelope at decision block 2003 and otherwise moves to block 2005. At block 2004, an upgrade performance indicator indicating the upgrade is unsatisfactory is returned. At block 2005, an upgrade performance indicator indicating the upgrade is satisfactory is returned.

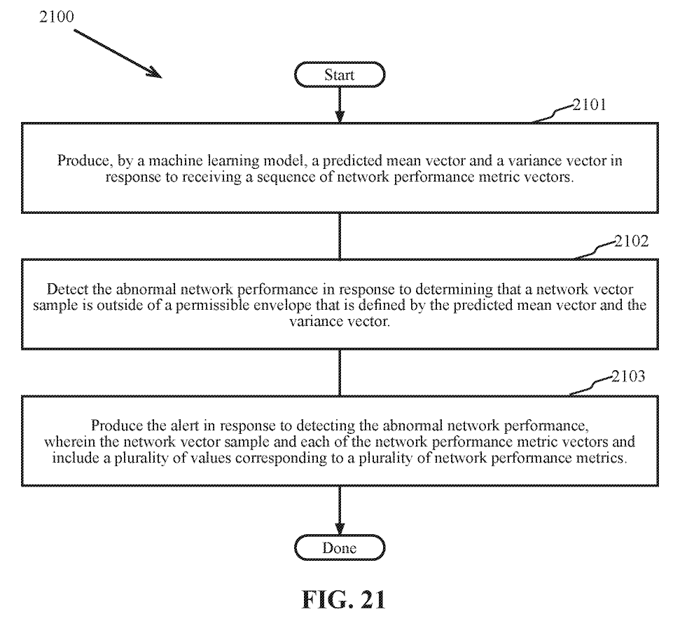

FIG. 21 is a high-level flow diagram illustrating an example of a method that uses a machine learning model to produce an alert in response to detecting abnormal network performance 2100, according to some aspects. Cloud server 102 or host machine 301 may implement the method illustrated in FIG. 21. At block 2101, a machine learning model produces a predicted mean vector and a variance vector in response to receiving a sequence of network performance metric vectors. At block 2102, abnormal network performance is detected in response to determining that a network vector sample is outside of a permissible envelope that is defined by the predicted mean vector and the variance vector. At block 2103, an alert is produced in response to detecting the abnormal network performance, wherein the network vector sample and each of the network performance metric vectors and include a plurality of values corresponding to a plurality of network performance metrics.

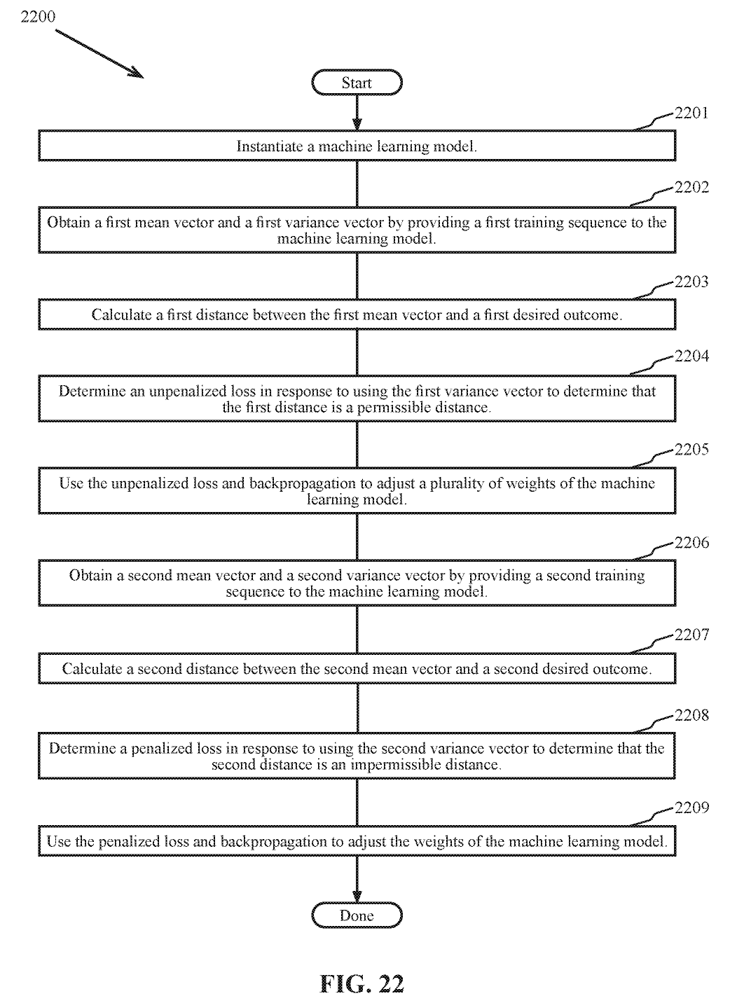

FIG. 22 is a high-level flow diagram illustrating an example of a method that trains a machine learning model to produce a predicted mean vector and a variance vector in response to receiving a sequence of network performance metric vectors 2200, according to some aspects. Cloud server 102 or host machine 301 may implement the method illustrated in FIG. 22. At block 2201, a machine learning model is instantiated. At block 2202, a first mean vector and a first variance vector are obtained by providing a first training sequence to the machine learning model. At block 2203, a first distance between the first mean vector and a first desired outcome is calculated. At block 2204, an unpenalized loss is determined in response to using the first variance vector to determine that the first distance is a permissible distance. At block 2205, the unpenalized loss and backpropagation are used to adjust a plurality of weights of the machine learning model. At block 2206, a second mean vector and a second variance vector are obtained by providing a second training sequence to the machine learning model. At block 2207, a second distance between the second mean vector and a second desired outcome is calculated. At block 2208, a penalized loss is determined in response to using the second variance vector to determine that the second distance is an impermissible distance. At block 2209, the penalized loss and backpropagation are used to adjust the weights of the machine learning model.

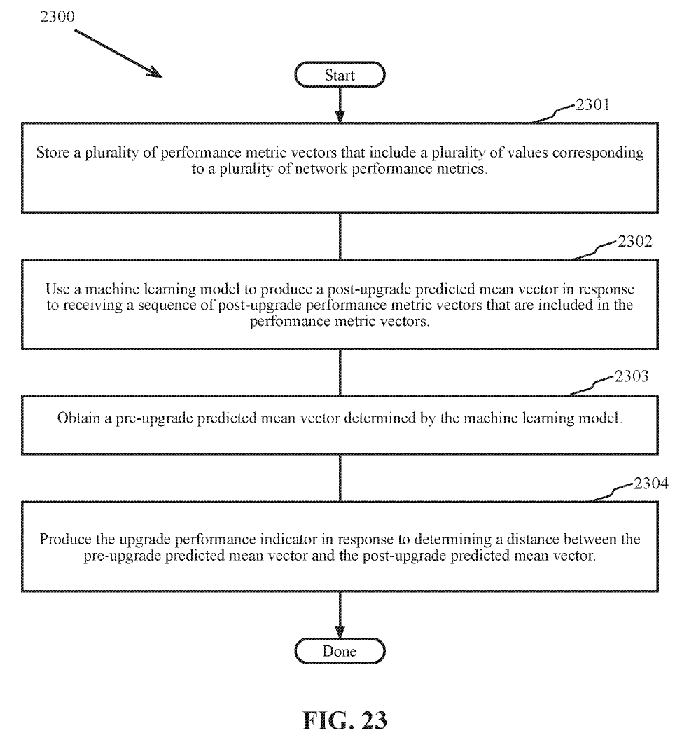

FIG. 23 is a high-level flow diagram illustrating an example of a method that produces an upgrade performance indicator for a network device 2300, according to some aspects. Cloud server 102 or host machine 301 may implement the method illustrated in FIG. 23. At block 2301, a plurality of performance metric vectors that include a plurality of values corresponding to a plurality of network performance metrics are stored. At block 2302, a machine learning model is used to produce a post-upgrade predicted mean vector in response to receiving a sequence of post-upgrade performance metric vectors that are included in the performance metric vectors. At block 2303, a pre-upgrade predicted mean vector determined by the machine learning model is obtained. At block 2304, the upgrade performance indicator is produced in response to determining a distance between the pre-upgrade predicted mean vector and the post-upgrade predicted mean vector.

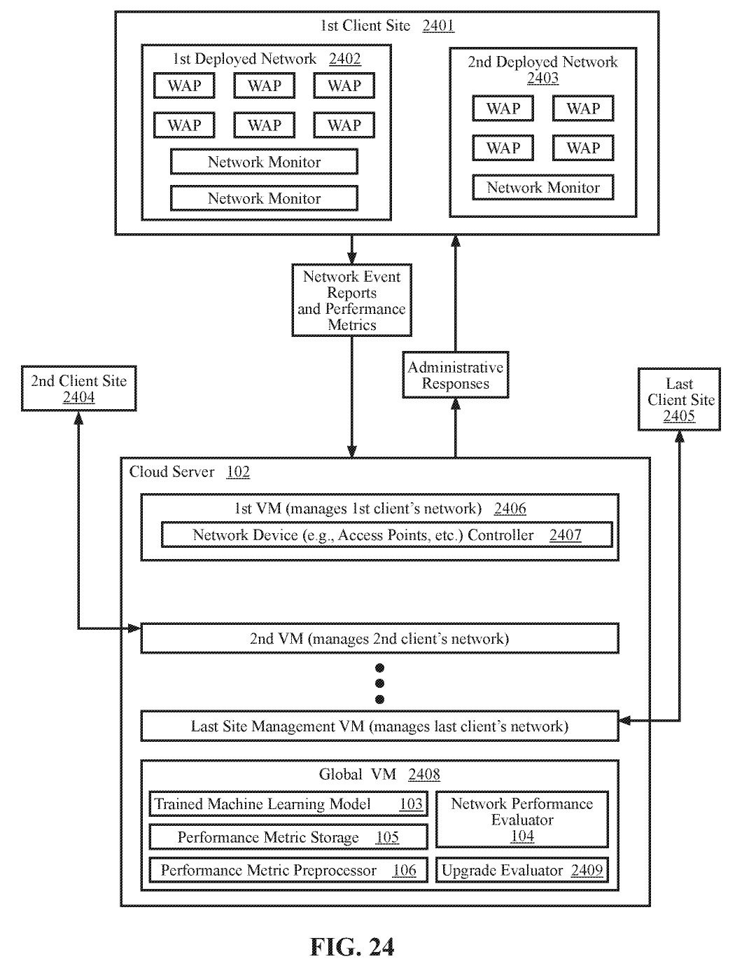

FIG. 24 is a high-level flow diagram illustrating an example of a cloud service, according to some aspects. In the example shown in FIG. 24, a communications system includes a cloud server 102, and networks deployed at client sites such as a first client site 2401, a second client site 2404, and a last client site 2405. The first client site 2401 is shown with a first deployed network 2402 and a second deployed network 2403. The cloud server and/or the networks may be implemented in hardware (e.g., circuits), software, firmware, or a combination thereof. Although the illustrated communications system is shown with certain components and described with certain functionality, other embodiments of the communications system may include fewer or more components to implement the same, less, or more functionality. For example, the communications system may include more than one cloud server, and more or fewer deployed networks at more or fewer customer sites. In another example, the cloud server and the deployed networks may be connected in a topology other than that shown in FIG. 24. The cloud server 102 can be used to provide at least one service to a customer site (e.g., to the deployed networks 2402, 2403 located at the first client site 2401). The cloud server may be configured to facilitate or perform a network management service (e.g., network device controller, abnormal network performance detection service, unsatisfactory upgrade detection service, etc.) to network devices (e.g., the WAPs in the deployed networks) at the customer sites. Because the cloud server can facilitate or perform a network management service or operation for network devices at the customer site, network management efficiency can be improved. In addition, because the cloud server can facilitate or perform a network management service or operation (e.g., network device control, abnormal network performance detection, unsatisfactory upgrade detection) for network devices at the customer site, such services and operations may be implemented without requiring a user or customer of the client site to be trained for or to perform such tasks. Consequently, network device control, abnormal network performance detection, and unsatisfactory upgrade detection may be implemented without burdening the clients. In some examples, the cloud server may be configured to generate a user interface to obtain input information such as a floor plan of a customer site. In some examples, the user interface includes a graphical user interface. The cloud server may be implemented in hardware (e.g., circuits), software, firmware, or a combination thereof. In some examples, the cloud server is hosted or executed in a public cloud computing environment such as Amazon Web Services (AWS), and/or a private cloud computing environment such as an enterprise cloud server. In some examples, the cloud server is implemented on a server grade hardware platform, such as an x86 architecture platform.

In an example, the cloud server 102 is shown running multiple virtual machines (VMs). The VMs may run one or more network device controller application. For example, the first virtual machine (VM) 2406 is shown running a network device controller 2407 for the deployed networks 2402, 2403 at the first client site 2401. In other examples, there may be a separate VM for each deployed network. In yet other examples, a service or operation (e.g., network device control, abnormal network performance detection, unsatisfactory upgrade detection) may run in one VM and may provide the service or operation to all of the client sites. The cloud server 102 is also shown running a global VM 2408 implementing performance metric storage 105 and running a trained machine learning model 103, a performance metric preprocessor 106, a network performance evaluator 104, and an upgrade evaluator 2409. The network performance evaluator 104 may implement a method such as the method illustrated in FIG. 21. The upgrade evaluator 2409 may run a method such as the method illustrated in FIG. 23. In other examples, a VM for each client or each network may implement the storage and applications shown in global VM 2408.

Although the operations of the methods and processes may be shown and described in a particular order, the order of the operations may be altered so that certain operations may be performed in an inverse order or so that certain operations may be performed, at least in part, concurrently with other operations. Alternatively, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described examples may also be implemented by operating a computer system to execute a sequence of machine-readable instructions. The computer readable instructions, when executed on one or more processors, may implement a method or process. The instructions may reside in various types of computer readable media. An example of a programmed product may include a computer readable medium tangibly storing a program of machine-readable instructions executable by a digital data processor to perform a method or process. The computer readable media may comprise memory (e.g., RAM) contained within the computer. Alternatively, the instructions may be contained in another computer readable media such as a magnetic data storage diskette and directly or indirectly accessed by a computer system. Whether contained in the computer system or elsewhere, the instructions may be stored on a variety of machine readable storage media, such as a hard drive, a solid state drive, a RAID array, magnetic tape, electronic read-only memory, an optical storage device (e.g., CD ROM, WORM, DVD, digital optical tape), paper “punch” cards. In an illustrative example, the machine-readable instructions may comprise lines of compiled C, C++, or similar language code commonly used by those skilled in the programming arts.

The foregoing description of examples will so fully reveal the general nature of the various aspects that others can, by applying current knowledge, readily modify and/or adapt for various applications the examples without departing from the generic concept, and, therefore, such adaptations and modifications should and are intended to be comprehended within the meaning and range of equivalents of the disclosed examples. It is to be understood that the phraseology or terminology employed herein is for the purpose of description and not of limitation. Therefore, those skilled in the art will recognize that the examples herein can be practiced with modification within the spirit and scope of the claims as described herein.

What is claimed is:

1. A method that produces an alert in response to detecting abnormal network performance, the method comprising:
producing, by machine learning model, a predicted mean vector and a variance vector in response to receiving a sequence of network performance metric vectors;
detecting the abnormal network performance in response to determining that a network vector sample is outside of a permissible envelope that is defined by the predicted mean vector and the variance vector; and
producing the alert in response to detecting the abnormal network performance,
wherein the network vector sample and each of the network performance metric vectors include a plurality of values corresponding to a plurality of network performance metrics.

2. The method of claim 1, wherein the machine learning model includes an encoder-decoder model.

3. The method of claim 1, wherein the machine learning model includes a transformer.

4. The method of claim 1, wherein:
the predicted mean vector includes predicted mean values corresponding to the network performance metrics; and
the variance vector includes a plurality of log-variance predictions corresponding to the predicted mean values.

5. The method of claim 1, wherein the predicted mean vector indicates a center of the permissible envelope and the variance vector indicates a size of the permissible envelope.

6. The method of claim 1, wherein the sequence of network performance metric vectors is a time series of network performance metric vectors corresponding to successive points in time at uniform intervals.

7. The method of claim 1, wherein the network performance metric vectors include a received signal strength indicator (RSSI) range count indicator corresponding to a number of user devices within an RSSI range.

8. The method of claim 1, wherein the network performance metric vectors include a plurality of dynamic host configuration protocol (DHCP) event count indicators that indicate numbers of user devices corresponding to a plurality of DHCP event types.

9. The method of claim 8, wherein each one of the user devices is represented no more than once in each one of the DHCP event count indicators.

10. The method of claim 1, wherein the network performance metric vectors include a plurality of latency range count indicators corresponding to a number of user devices having latency within specified ranges.

11. The method of claim 10, wherein the latency range count indicators correspond to a plurality of connection types.

12. The method of claim 1, wherein:
the network performance metric vectors include a value determined from a count that indicates a number of user devices corresponding to a network performance metric; and
the value is produced by a function that maps the count to a range bounded by zero and one, the value asymptotically approaching one as the count approaches infinity.

13. The method of claim 1, further includes training the machine learning model, wherein training the machine learning model includes:
obtaining a candidate mean vector and a candidate variance vector by providing a training sequence to the machine learning model;
calculating a loss that represents a distance between the candidate mean vector and a desired outcome;
increasing the loss in response to determining that the distance is an impermissible distance; and
using backpropagation to adjust a plurality of weights of the machine learning model based on the loss.

14. A method comprising:
producing a trained machine learning model configured to produce a predicted mean vector and a variance vector in response to receiving a sequence of network performance metric vectors, by:
instantiating a machine learning model;
obtaining a first mean vector and a first variance vector by providing a first training sequence to the machine learning model;
calculating a first distance between the first mean vector and a first desired outcome;
determining an unpenalized loss in response to using the first variance vector to determine that the first distance is a permissible distance;
using the unpenalized loss and backpropagation to adjust a plurality of weights of the machine learning model;
obtaining a second mean vector and a second variance vector by providing a second training sequence to the machine learning model;
calculating a second distance between the second mean vector and a second desired outcome;
determining a penalized loss in response to using the second variance vector to determine that the second distance is an impermissible distance; and
using the penalized loss and backpropagation to adjust the weights of the machine learning model.

15. The method of claim 14, further including:
producing, by the machine learning model, an alert in response to detecting abnormal network performance by:
producing, by the machine learning model, the predicted mean vector and the variance vector in response to receiving the sequence of network performance metric vectors;
detecting the abnormal network performance in response to determining that a network vector sample is outside of a permissible envelope that is defined by the predicted mean vector and the variance vector; and
producing the alert in response to detecting the abnormal network performance,
wherein the network vector sample and each of the network performance metric vectors and include a plurality of values corresponding to a plurality of network performance metrics.

16. The method of claim 15, wherein the machine learning model includes a transformer.

17. The method of claim 16, wherein:
the predicted mean vector includes predicted mean values corresponding to the network performance metrics; and
the variance vector includes a plurality of log-variance predictions corresponding to the predicted mean values.

18. The method of claim 15, wherein:
the network performance metric vectors include a value determined from a count that indicates a number of user devices corresponding to a network performance metric; and
the value is produced by a function that maps the count to a range bounded by zero and one, the value asymptotically approaching one as the count approaches infinity.

19. A system comprising:
a memory configured to store a machine learning model and to store a sequence of network performance metric vectors and a network vector sample; and
a processor configured to produce an alert in response to detecting abnormal network performance, wherein detecting the abnormal network performance includes:
producing a predicted mean vector and a variance vector by providing the sequence of network performance metric vectors to the machine learning model; and
detecting the abnormal network performance in response to determining that the network vector sample is outside of a permissible envelope that is defined by the predicted mean vector and the variance vector,
wherein the network vector sample and each of the network performance metric vectors and include a plurality of values corresponding to a plurality of network performance metrics.

20. The system of claim 19, wherein the machine learning model is trained by:
obtaining a first mean vector and a first variance vector by providing a first training sequence to the machine learning model;
calculating a first distance between the first mean vector and a first desired outcome;
determining an unpenalized loss in response to using the first variance vector to determine that the first distance is a permissible distance;
using the unpenalized loss and backpropagation to adjust a plurality of weights of the machine learning model;
obtaining a second mean vector and a second variance vector by providing a second training sequence to the machine learning model;
calculating a second distance between the second mean vector and a second desired outcome;
determining a penalized loss in response to using the second variance vector to determine that the second distance is an impermissible distance; and
using the penalized loss and backpropagation to adjust the weights of the machine learning model.
